(19) United States
(12) Patent Application Publication
(10) Pub. No.: US 2026/0077995 A1
(43) Pub. Date: Mar. 19, 2026

(54) FLUID STORAGE AND DISPENSING SYSTEM

(71) Applicant: Garrett Smith, Tulsa, OK (US)

(72) Inventor: Garrett Smith, Tulsa, OK (US)

(21) Appl. No.: 19/330,454

(22) Filed: Sep. 16, 2025

Related U.S. Application Data
(60) Provisional application No. 63/695,315, filed on Sep. 16, 2024.
(60) Provisional application No. 63/707,140, filed on Oct. 14, 2024.

(51) Int. Cl. B67D 7/04; B65D 25/48; B65D 47/06; B65D 47/24; B65D 47/32; B65D 50/06; B67D 7/42

(52) U.S. Cl. CPC B67D 7/04; B65D 25/48; B65D 47/065; B65D 47/247; B65D 47/32; B65D 50/06; B67D 7/42; B65D 2215/04; B65D 2547/066

(57) ABSTRACT

A fluid storage and/or dispensing system includes a fluid container having a hollow interior adapted to contain a fluid, such as gas, to be dispensed. A fluid dispenser has a dispenser passageway extending from an inlet end to an outlet end. A venting system is provided within the dispenser body. The venting system includes one or more air inlets in the dispenser body that introduce air into the dispenser passageway and vents a sufficient amount of air back into the fluid container to decrease negative pressure generated within the fluid container during dispensing. A self-closing valve system include a valve member that prevents the flow of fluid from the fluid container into the dispenser body and an actuating mechanism that can be manipulated by a user to open the valve member and allow fluid to flow from the fluid container into the dispenser body.

### PRIORITY

The present application claims the benefit of domestic priority based on U.S. Provisional Patent Application 63/707,140 filed on Oct. 14, 2024 and U.S. Provisional Patent Application 63/695,315 filed on Sep. 16, 2024, the entireties of which are incorporated herein by reference.

### BACKGROUND

It is often desirable, and sometimes government-mandated, that dispensers for some fluid containers be designed with environmental and/or safety features.

One such fluid container that is potentially hazardous and/or environmentally impactful is the fuel container, especially the portable fuel container also known as a PFC or a gas can. Portable fuel containers are used to store fuel for later filling into equipment such as vehicles, generators, gas-operated tools, such as lawnmowers and chain saws, and the like. The household use of portable fuel containers is ubiquitous, and because of this widespread availability, portable fuel containers have become highly regulated. For example, some state legislation and/or EPA regulations have placed requirements on the way in which portable fuel containers can be operated.

Because portable fuel containers have the potential to create substantial hydrocarbon emissions, regulations have been enacted that are aimed at reducing the emissions. One such regulation involves the elimination of vents in the container that were provided to help the flow of fuel during a dispensing process. When fuel was poured from the fuel container, the vents would allow air to fill the space vacated by the fuel during the pour. As it turned out, the vents were a source of the emission of some fuel or vapors into the environment, and regulations were enacted to eliminate the old vents. To comply with the regulations, self-venting dispensers have been attempted to be developed. However, self-venting dispensers have proven to date to be problematic and have created dispensing difficulties. For example, conventional self-venting dispensers cause the dispensed fluid to dispense slowly and in turbulent streams.

In addition, other regulations have been enacted. For example, in order to further prevent or reduce emissions and to prevent spillage, regulations have been introduced that require dispensers to automatically close and seal when not in use. These automatic seals have suffered from their own problems. For example, one type of dispenser is designed so that it is normally closed but when the dispenser engages and is pushed against the rim of a receiving tank a spring-loaded self-closing spout is opened to allow fluid to be dispensed. However, with this system the rim of the receiving tank must have a suitable geometry that allows engagement with the dispenser. In addition, the receiving tank must be able to support the weight and force of the dispenser and container in order to prevent tipping and spillage. Another type of dispenser includes a manually operable trigger, lever, or button that is actuated by a user to allow fluid to be dispensed from the dispenser. However, with this system, a user must maintain the trigger, lever, or button in an actuated position with one hand while awkwardly holding and controlling the fluid container in the other hand. In addition, the dispenser's geometry can make it difficult to support the weight of a heavy container, especially while performing these coordinated actions that are required for dispensing the fuel.

The combination of these requirements exacerbates the problem. A user having to battle the awkwardness of dispensing from the automatic closure system only to find the flow of the fuel to be undesirably slow or turbulent because of the self-venting system can easily become frustrated and become tempted to remove the dispenser and pour directly from the container thereby creating a hazardous situation and one that increases emissions rather than lessens them.

It can also be desirable and/or a governmental requirement to provide a child-resistant mechanism for a fluid dispenser. This has proven to be particularly difficult when combined with other requirements or desires, such as a self-closing dispensing feature. Current designs require a user to repeatedly unlock the child-resistant mechanism each time the dispensing is temporarily stopped, which can be frustrating and inefficient. Current child-resistant mechanisms also can make it difficult to alter or control the flow through the dispenser. For example, a user may want to slow the flow by partially closing the dispenser and inadvertently activate the child-resistant mechanism.

There is therefore a need for an improved system for storing and/or dispensing a fluid from a container, particularly when there is a desire or requirement to limit the emissions and/or spillage of the fluid during storage and/or dispensing. There is further a need for a fluid dispenser with an improved self-venting system. There is further a need for a fluid dispenser with an improved self-closing mechanism and/or mechanism for releasing a self-closing mechanism. There is further a need for an improved child-resistant mechanism for a fluid storage and/or dispensing system.

### SUMMARY

The present invention satisfies these needs. In one aspect of the invention, an improved system for storing and/or dispensing a fluid from a container is provided.

In another aspect of the invention, an improved system for storing and/or dispensing a fluid from a container reduces unwanted emission of the fluid.

In another aspect of the invention, an improved system for storing and/or dispensing a hazardous, harmful, and/or combustible fluid, such as a fuel, from a container reduces unwanted emission of the fluid.

In another aspect of the invention, an improved system for storing and/or dispensing gasoline from a container reduces unwanted emission of the fluid.

In another aspect of the invention, a system for storing and/or dispensing a fluid from a container reduces unwanted emission of the fluid by providing an improved self-venting system when compared to conventional vents.

In another aspect of the invention, a system for storing and/or dispending a fluid from a container comprises a venting system with a counterflow system comprising a first channel and a second channel, wherein fluid to be dispensed flows in a first direction in the first channel and air flows in a second direction in the second channel.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process, wherein the counterflow system comprises a first channel and a second channel, and wherein fluid from the fluid container flows in the first channel in the first of the inlet to the outlet.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process, wherein the counterflow system comprises a first channel and a second channel, wherein fluid from the fluid container flows in the first channel in the first of the inlet to the outlet, and wherein air flows in the second channel in the opposite direction to the flow of fluid in the first channel.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process, wherein the counterflow system comprises a first channel and a second channel, wherein fluid from the fluid container flows in the first channel in the first of the inlet to the outlet, and wherein air flows in the second channel from an air chamber in the fluid dispenser towards the dispenser inlet.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process, wherein the counterflow system comprises a first channel and a second channel, wherein fluid from the fluid container flows in the first channel in the first of the inlet to the outlet, wherein air flows in the second channel from an air chamber in the fluid dispenser towards the dispenser inlet, and wherein the fluid dispenser comprises one or more air inlets that allow air to flow into the air chamber.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system at least partially contained in an insert member insertable into an outer shell of a dispenser body, wherein the counterflow system allows for self-venting of the fluid container during a dispensing process, wherein the counterflow system comprises a first channel and a second channel, wherein fluid from the fluid container flows in the first channel in the first of the inlet to the outlet, and wherein air flows in the second channel in the opposite direction to the flow of fluid in the first channel.

In another aspect of the invention, a system for storing and/or dispensing a fluid comprises a dispenser adapted to be in communication with a fluid container to selectively dispense fluid from the fluid container, the fluid dispenser comprising a dispenser passageway extending from a dispenser inlet to a dispenser outlet, wherein the dispenser passageway comprises a counterflow system that allows for self-venting of the fluid container during a dispensing process, wherein the counterflow system comprises a first channel and a second channel, wherein fluid from the fluid container flows in the first channel in the first of the inlet to the outlet, wherein air flows in the second channel in the opposite direction to the flow of fluid in the first channel, and wherein the dispenser outlet comprises a detachable nozzle having a reservoir sized to prevent backflow into the counterflow system.

In another aspect of the invention, a system for storing and/or dispensing a fluid from a container reduces unwanted emission of the fluid by providing an improved self-closing system.

In another aspect of the invention, a system for storing and/or dispensing a fluid from a container reduces unwanted emission of the fluid by providing an improved self-venting system and improved self-closing system.

In another aspect of the invention, a system for storing and/or dispensing a fluid from a container includes a self-venting system with improved flow qualities.

In another aspect of the invention, a system for storing and/or dispensing a fluid from a container includes a self-closing system that is easily manipulatable by a user.

In another aspect of the invention, a system for storing and/or dispensing a fluid from a container includes a self-closing system that is easily manipulatable by a user and that includes a child-resistant safety feature.

In another aspect of the invention, a system for storing and/or dispensing a fluid from a container includes a self-closing system that is easily manipulatable by a user and that includes a child-resistant safety feature that is operable with a single hand while using the hand to open the open the self-closing system.

In another aspect of the invention, an improved fluid container is provided.

In another aspect of the invention, a method of using a system for storing and/or dispensing a fluid from a container includes providing a system for storing and/or dispensing a fluid from a container including any of the features described herein.

In another aspect of the invention, a fluid dispenser for a fluid storage and dispensing system comprises a dispenser body having an inlet end, an outlet end, and a dispenser passageway extending from the inlet end to the outlet end, wherein the inlet end is adapted to be in fluid communication with an opening in a fluid container, and wherein fluid from the fluid container can flow from the inlet end, through the dispenser passageway, and out the outlet end when fluid from the fluid container is to be dispensed; and a venting system within the dispenser body, wherein the venting system communicates with the dispenser passageway, wherein the venting system comprises one or more air inlets that introduce air into the dispenser passageway, and wherein the venting system comprises a counterflow system adapted to allow air from the one or more air inlets to be introduced back into the fluid container through the inlet end of the dispenser body while fluid from the fluid container is flowing through the dispenser passageway from the inlet end of the dispenser body to the outlet end of the dispenser body, wherein the venting system is adapted to vent a sufficient amount of air back into the fluid container to decrease negative pressure generated within the fluid container as a result of the fluid from the fluid container flowing into the fluid dispenser.

In another aspect of the invention, a fluid dispenser for a fluid storage and dispensing system comprises a dispenser body having an inlet end, an outlet end, and a dispenser passageway extending from the inlet end to the outlet end, wherein the inlet end is adapted to be in fluid communication with an opening in a fluid container, and wherein fluid from the fluid container can flow from the inlet end, through the dispenser passageway, and out the outlet end when fluid from the fluid container is to be dispensed; and a self-closing valve system comprising a valve member and an actuating mechanism, wherein the valve member is biased into a closed position where the valve member prevents the flow of fluid from the fluid container into the dispenser body, and wherein the actuating mechanism comprises a handle body that can be rotated by a user to overcome the bias and move the valve member to an open position that allows fluid to flow from the fluid container into the dispenser body.

In another aspect of the invention, a fluid storage and dispensing system comprises a fluid container comprising a container body having a hollow interior adapted to contain a fluid to be dispensed, the container body comprising an opening; a fluid dispenser comprising a dispenser body having an inlet end, an outlet end, and a dispenser passageway extending from the inlet end to the outlet end, wherein the inlet end is adapted to be in fluid communication with the opening in a fluid container, wherein fluid from the fluid container can flow through the opening and into the dispenser body, and wherein the fluid can flow from the inlet end, through the dispenser passageway, and out the outlet end when fluid from the fluid container is to be dispensed; a venting system within the dispenser body, wherein the venting system communicates with the dispenser passageway, wherein the venting system comprises one or more air inlets in the dispenser body that introduce air into the dispenser passageway, and wherein the venting system is adapted to vent a sufficient amount of air back into the fluid container through the opening in the fluid container to decrease negative pressure generated within the fluid container as a result of the fluid from the fluid container flowing into the fluid dispenser; and a self-closing valve system comprising a valve member and an actuating mechanism, wherein the valve member extends through the dispenser body and is biased into a closed position where the valve member prevents the flow of fluid from the fluid container into the dispenser body, and wherein the actuating mechanism can be manipulated by a user to overcome the bias and move the valve member to an open position that allows fluid to flow from the fluid container into the dispenser body.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic side view of a version of a fluid storage and dispensing system of the invention;

FIG. 2A is a schematic perspective side and rear view of a version of a fluid dispenser of the fluid storage and dispensing system of FIG. 1;

FIG. 2B is a schematic sectional side view of the fluid dispenser of FIG. 2A;

FIG. 3A is a schematic perspective side and rear view of another version of a fluid dispenser of the fluid storage and dispensing system of FIG. 1;

FIG. 3B is a schematic sectional side view of the fluid dispenser of FIG. 3A;

FIG. 4A is a schematic perspective exploded view of another version of a fluid dispenser of the fluid storage and dispensing system of FIG. 1;

FIG. 4B is a schematic perspective assembled view from below and to the side of the fluid dispenser of FIG. 4A;

FIG. 5A is a schematic perspective view from above and to the side of the fluid dispenser of FIG. 4A assembled;

FIG. 5B is a schematic sectional side view of the fluid dispenser of FIG. 4A assembled;

FIG. 6 is a schematic perspective view from below and to the side of an insert member of the version of the fluid dispenser of FIG. 4A;

FIG. 7A is a schematic perspective view from above and to the side of another version of a fluid dispenser of the fluid storage and dispensing system of FIG. 1;

FIG. 7B is a schematic sectional side view of the fluid dispenser of FIG. 7A;

FIG. 8A is a schematic perspective view from above and to the side of another version of a fluid dispenser of the fluid storage and dispensing system of FIG. 1;

FIG. 8B is a schematic sectional side view of the fluid dispenser of FIG. 8A;

FIG. 9A is a schematic perspective view from above and to the side of another version of a fluid dispenser of the fluid storage and dispensing system of FIG. 1;

FIG. 9B is a schematic perspective view from above and to the side of another version of a fluid dispenser of the fluid storage and dispensing system of FIG. 1;

FIG. 10 is a schematic side view of another version of a fluid storage and dispensing system of the invention with a fluid dispenser comprising a self-closing valve system;

FIG. 11A is a schematic perspective view from above, rear, and side of a version of a dispenser assembly in accordance with the fluid storage and dispensing system of FIG. 10;

FIG. 11B is a schematic sectional side view of the dispenser assembly of FIG. 11A;

FIG. 12A is a schematic perspective view from above, front, and side of a version of a fluid dispenser in accordance with the dispensing system of FIG. 10 with an actuating mechanism in a closed position;

FIG. 12B is a schematic side view of the fluid dispenser of FIG. 12A with an actuating mechanism in a closed position;

FIG. 13A is a schematic perspective view from above, front, and side of a version of a fluid dispenser in accordance with the dispensing system of FIG. 10 with an actuating mechanism in an open position;

FIG. 13B is a schematic side view of the fluid dispenser of FIG. 13A with an actuating mechanism in an open position;

FIG. 14A is a schematic perspective view of the front side of a handle body of an actuating mechanism of the fluid storage and dispensing system of FIG. 10;

FIG. 14B is a schematic perspective view of the rear side of a handle body of an actuating mechanism of the fluid storage and dispensing system of FIG. 10;

FIG. 15 is a schematic perspective view from above, front, and side of a version of a fluid dispenser in accordance with the fluid storage and dispensing system of FIG. 10 with the actuating mechanism not shown;

FIG. 16 is a schematic exploded perspective view from above, behind, and side of the fluid dispenser FIG. 15 with the actuating mechanism not shown;

FIG. 17A is a schematic perspective view from above, rear, and side of an internal portion of the fluid dispenser of the FIG. 15;

FIG. 17B is a schematic perspective exploded view from above, rear, and side of the internal portion of the fluid dispenser of FIG. 17A;

FIG. 18 is a schematic sectional side view of a version of a fluid dispenser in accordance with the fluid storage and dispensing system of FIG. 10 with an actuating mechanism in a closed position;

FIG. 19 is a schematic sectional side view of the fluid dispenser of the fluid storage and dispensing system of FIG. 18 with an actuating mechanism in an open position;

FIG. 20 is a schematic side view of a version of the fluid storage and dispensing system with an actuating mechanism in a storage position;

FIG. 21A is a schematic sectional side view of a fluid dispenser of the fluid storage and dispensing system of FIG. 20 with an actuating mechanism in a storage position;

FIG. 21B is a schematic sectional side view of the fluid dispenser of FIG. 21A with an actuating mechanism in a storage position and with a nozzle;

FIG. 22A is a schematic perspective view from above, front, and side of a version of a child-resistant dispenser actuating mechanism connected to a dispenser assembly with the dispenser actuating mechanism in a locked configuration and a closed position;

FIG. 22B is a schematic perspective view from below, rear, and side of the dispenser actuating mechanism and dispenser assembly of FIG. 22A with the dispenser actuating mechanism in a locked configuration and a closed position;

FIG. 23A is a schematic perspective view from above, front, and side of the dispenser assembly and dispenser actuating mechanism of FIG. 22A with the dispenser actuating mechanism in an unlocked configuration and a closed position;

FIG. 23B is a schematic perspective view from above, front, and side of the dispenser assembly and dispenser actuating mechanism of FIG. 22A with the dispenser actuating mechanism in an unlocked configuration and an open position;

FIG. 24A is a schematic detailed view of the interior of the dispenser actuating mechanism of the version of FIG. 22A;

FIG. 24B is a schematic exploded view of the dispenser actuating mechanism of FIG. 24A;

FIG. 25A is a schematic perspective view from below of the rear side of a locking member of the dispenser actuating mechanism of FIG. 22A;

FIG. 25B is a schematic perspective view from above of the rear of the locking member of FIG. 25A;

FIG. 26 is a schematic sectional side view of a version of a fluid dispenser with a dispenser actuating mechanism of FIG. 22A in a closed position;

FIG. 27 is a schematic sectional side view of a version of a fluid dispenser with a dispenser actuating mechanism of FIG. 22A in an open position;

FIG. 28 is a schematic side view of another version of a fluid storage and dispensing system of the invention;

FIG. 29A is a schematic perspective view from above and to the side of a version of the dispensing system of the fluid storage and dispensing system of FIG. 28;

FIG. 29B is a schematic perspective view from above and to the side of a version of the dispensing system of the fluid storage and dispensing system of FIG. 28;

FIG. 30 is a schematic perspective view from above and the front of a version of a fluid container of the fluid storage and dispensing system of the invention;

FIG. 31 is a schematic side view of the fluid container of FIG. 30;

FIG. 32 is a schematic front view of the fluid container of FIG. 30; and

FIG. 33 is a schematic top view of the fluid container of FIG. 30.

### DESCRIPTION

The present invention relates to the storage and/or dispensing of a fluid from a container. In particular, the invention relates to a fluid storage and dispensing system for dispensing fluid stored in a fluid container. Although the fluid dispensing system is illustrated and described in the context of being useful for dispensing fuel from a fuel container, the present invention can be useful in other instances. Accordingly, the present invention is not intended to be limited to the examples and embodiments described herein.

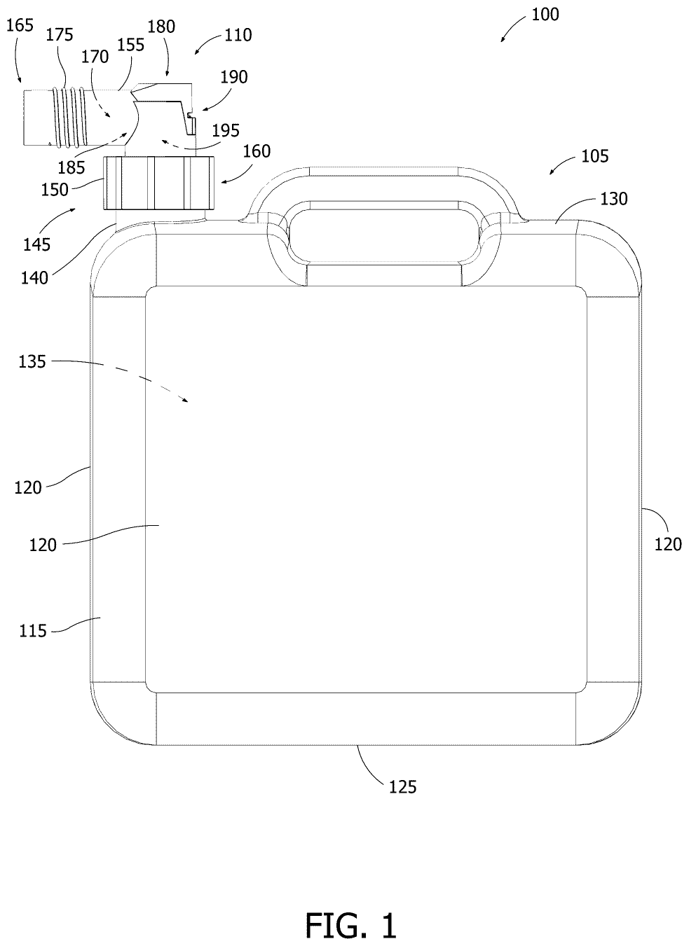

FIG. 1 shows a fluid storage and dispensing system 100 according to the invention. The fluid storge and dispensing system 100 comprises a fluid container 105 and a fluid dispenser 110. The fluid container 105 includes a container body 115 made up of a plurality of sidewalls 120, a bottom wall 125, and a top wall 130 that together define a hollow interior 135 adapted to contain a fluid. An opening 140 in the container body 115 is adapted to receive or otherwise connect to the fluid dispenser 110. A connection mechanism 145 is provided to releasably and sealingly connect the fluid dispenser 110 to and/or within the opening 140 in the fluid container 105, such as a threaded container cap 150 or the like. The fluid dispenser 110 has a dispenser body 155 that extends from an inlet end 160 adapted to be in communication with the hollow interior 135 of the fluid container 105 and an outlet end 165 that is exterior to the hollow interior 135 when the fluid dispenser 110 is connected to the fluid container 105. Within the dispenser body 155, an internal dispenser passageway 170 extends internally from the inlet end 160 to the outlet end 165, as will be described in more detail hereinbelow. The fluid dispenser 110 is designed and arranged to selectively dispense fluid that is contained within the fluid container 105 from the hollow interior 135 into the inlet end 160, through the dispenser passageway 170, and out the outlet end 165 into a fluid receiving member, such as a receiving tank or conduit.

In the version shown, the fluid contained within the fluid container 105 is caused to be dispensed by tilting the fluid storage and dispensing system 100. More specifically, the flow of fluid through the dispenser passageway 170 and out the outlet end 165 is caused by tilting the fluid storage and dispensing system 100 in a forward direction or rotating the fluid storage and dispending system 100 about a horizontal axis extending from left to right of the fluid storage and dispending system 100. When the tilt or rotation is sufficient, the fluid in the fluid container 105 is poured through the opening 140 in the fluid container 105 and into the inlet end 160 of the dispenser passageway 170 in the dispenser body 155. By continuing to tilt or maintaining a sufficient tilt, the fluid flows through the dispenser passageway 170 to the outlet end 165 where it exits the dispenser body 155. The dispenser body 155 at or near the outlet end 165 can optionally include a nozzle connector 175, such as threads or the like, to optionally connect a nozzle to the outlet end 165 of the fluid dispenser 110. Alternatively, no nozzle can be provided, and fluid can be dispensed directly from the outlet end 165 or the outlet end 165 can be designed to include an integrated nozzle.

The fluid dispenser 110 includes a venting system 180 that communicates and/or cooperates with an intermediate portion 185 of the dispenser passageway 170 between the inlet end 160 and the outlet end 165. The venting system 180 is designed to allow the fluid dispenser 110 to self-vent during a dispensing process. The venting system 180 comprises one or more air inlets 190 that are designed to introduce air into the dispenser passageway 170 of the fluid dispenser 110 while the fluid dispenser 110 is dispensing fluid from the fluid container 105. The venting system 180 also comprises a counterflow system 195 within the intermediate portion 185 of the dispenser passageway 170. The counterflow system 195 is designed to allow air from the one or more air inlets 190 to traverse through the dispenser passageway 170 so that air can be introduced back into the fluid container 105 through the opening 140 as fluid that is to be dispensed is exiting the fluid container 105. The venting system 180 is designed so that the venting of air back into the fluid container 105 is sufficient to decrease negative pressure generated within the fluid container 105 as a result of the dispensing process and to allow for an improved amount and/or quality of flow through the dispenser 110 and out the outlet end 165.

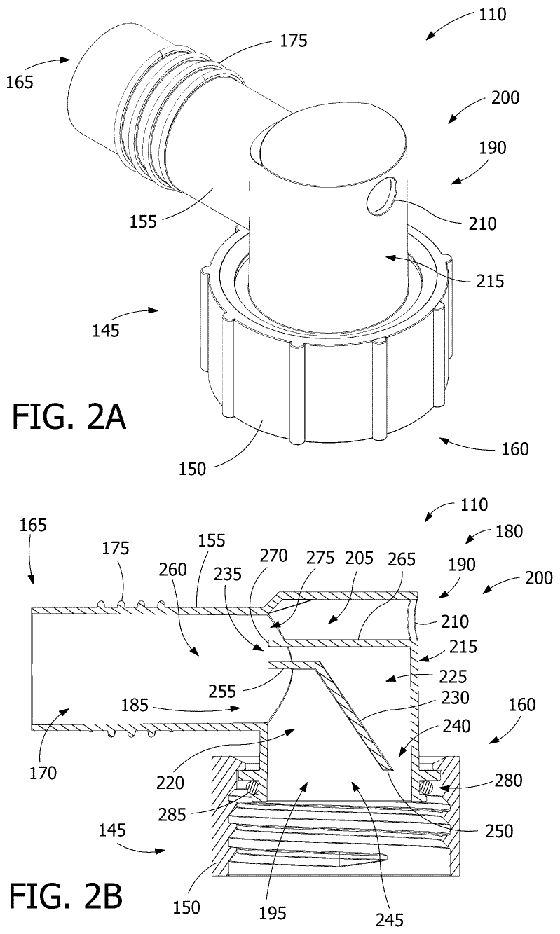

FIG. 2A shows a version of a fluid dispenser 110 of the fluid storage and dispensing system 100 with the fluid dispenser 110 removed from the fluid container 105. FIG. 2A shows a dispenser assembly 200 comprising the dispenser body 155 and container cap 150 of the fluid dispenser 110. FIG. 2B shows a cross-sectional representation of the dispenser assembly 200 of the version of the fluid dispenser 110 of FIG. 2A. As can be seen, in this version, the venting system 180 comprises an air chamber 205 within the dispenser body 155, and the one or more air inlets 190 of the venting system 180 are in communication with the air chamber 205 so that air from outside the dispenser body 155 can pass through the one or more air inlets 190 to fill the air chamber 205. In the particular version of FIG. 2A, the one or more air inlets 190 comprises a rear opening 210 on a rear surface 215 of the dispenser body 155. In this version, the rear opening 210 allows air to enter into the air chamber 205 in a general direction that is generally or substantially aligned or in plane with a direction of flow of liquid through the dispenser passageway 170 and/or that is at least partially aligned with an axis that is not parallel with, such as by being perpendicular to, an axis of rotation of the pouring tilt of the fluid storage and dispensing system 100. This directional air flow can lead to less turbulent flow than other directions. The counterflow system 195 of the venting system 180 of the fluid dispenser 110 is in communication with the air chamber 205 so that air within the air chamber 205 can be vented to the fluid container 105 as fluid is being poured from the fluid container 105.

In the version of FIGS. 2A and 2B, the counterflow system 195 comprises a first channel 220, or fluid channel, that is at least predominantly for the passage of fluid in the direction from the inlet end 160 to the outlet end 165. The counterflow system 195 also comprises a second channel 225, or air channel, that is at least predominantly for the passage of air in the direction from the air chamber 205 to the inlet end 160. Optionally, the first channel 220 and the second channel 225 are separated from one another by a channel barrier member 230 that helps to separate the air flowing in the counterflow direction in the second channel 225 from interfering with the flow of fluid in the first channel 220, even though there may be some fluid from the fluid container 105 flowing in the outlet end direction in the second channel 225. The second channel 225 extends from an air channel inlet 235 that is in proximity to and/or in communication with the air chamber 205 to an air channel outlet 240 that opens into a lower portion 245 of the dispenser passageway 170. The lower portion 245 of the dispenser passageway 170 is in proximity to and/or in communication with the opening 140 into the fluid container 105. The second channel 225 thus allows air to flow from the air chamber 205 through the air channel outlet 240 so that it can then flow into to the fluid container 105. Alternatively, the air channel outlet 240 can be positioned at or beyond the inlet end 160 so that air passes directly from the second channel 225 to the opening 140 of the fluid container 105.

The counterflow system 195 of the venting system 180 of the fluid dispenser 110 can be designed in a manner that advantageously manages the flow of the fluid through the first channel 220 and/or the flow of air through the second channel 225. For example, in the region in proximity to the air channel outlet 240, a fluid channel dividing end 250 may be designed to help separate the first channel 220 and the second channel 225 in the lower portion 245 in a manner that helps to block or discourage the passage of fluid from the fluid container 105 from entering the air channel outlet 240 and/or helps to direct the fluid from the fluid container 105 towards the first channel 220 during the dispensing process. Additionally, the channel barrier member 230 can include a flow directing portion 255 that serves to direct the flow of fluid in the first channel 220 towards and/or into an upper portion 260 of the dispenser passageway 170 and/or towards the outlet end 165 during a dispensing process. This helps to prevent fluid in the first channel 220 from flowing into the air chamber 205. Alternatively, a flow director similar to the flow directing portion of the of the channel barrier member 230 can be provided separate from or instead of the channel barrier member 230. In addition, an air chamber shielding member 265 can be provided at or near the air channel inlet 235 of the second channel 225 to provide additional separation between the air chamber 205 and the second channel 225 in case fluid flows into the second channel 225. The air chamber shielding member 265 can also serve to direct the flow of any fluid in the second channel 225 towards or into the upper portion 260 of the dispenser passageway 170 and/or towards the outlet end 165. In the version shown, the air chamber shield member 265 has a forward end 270 that extends in a forward direction at least as far as the forwardmost portion of the internal opening of the inlet end 160 of the dispenser body. The forward end 270 also helps define an air chamber outlet 275.

The arrangement and positioning of the features of the version of FIGS. 2A and 2B offer additional advantages. For example, by positioning the air channel outlet 240 at a rear portion of the dispenser passageway 170, such as at or near a rearward most position, fluid from the fluid container 105 is further discouraged from passing through the air channel outlet 240. The rearward positioning of the air channel outlet 240 also provides protection against excessive spilling in the event of the fluid storage and dispensing system 100 being shaken or being tilted in a direction opposite to the tilt for dispensing. In such case, a small amount of fluid from the fluid container 105 might pass through the air channel outlet 240, but due to the position of the opening 140 on the fluid container 105 and/or due to the presence of an air chamber shielding member 265 near the air channel inlet 235, little if any fluid is able to enter the air chamber, as long as the wrongful tilt is not excessive, and the fluid will merely flow back into the fluid container 105 when the shaking or wrongful tilt is completed.

The features and/or sizes and dimensions of the features of the fluid dispenser 110 of FIGS. 2A and 2B can be selected to advantageously control the flow of fluid and/or air through the dispenser passageway 170 of the fluid dispenser 110. For example, the size of the opening at the outlet end 165 and/or any tubes or openings downstream from the outlet end 165 should be sufficiently large to prevent clogging or backflow of the fluid passing through the fluid dispenser 110. Backflow can lead to fluid entering the air chamber 205 which can result in leakage through an air inlet 190 and/or can interfere with the passage of air from the air chamber 205 to the second channel 225 during a dispensing process. Accordingly, in one version the cross-sectional area of the smallest opening or passage downstream of the venting system 180 should be at least as large or larger than the cross-sectional area of the smallest portion of the first channel 220 and/or the smallest portion of the first channel 220 plus the smallest portion of the second channel 225. In another version, the cross-sectional area of the smallest opening or passage downstream of the venting system 180 can be reduced and combined with a backflow prevention system, as will be discussed. Also, the total cross-sectional area of the one or more inlets 190 should be about the same or greater than the cross-sectional area of the air channel outlet 240 to make sure there is as much air coming into the air chamber 205 as there is leaving the air chamber 205 and second channel 225. Also, the smallest cross-sectional area for each of the air chamber 205, air channel inlet 235, second channel 225, and air channel outlet 240 should be about the same or greater than the total cross-sectional area of the one or more inlets 190 to make sure there is as much air coming into the air chamber 205 as there is leaving the air chamber 205 and the second channel 225. In addition, the dispenser body 155 can include an O-ring retaining mechanism 280 to position an O-ring 285 where it provides a fluid-tight seal between the dispenser body 155 and the opening 140.

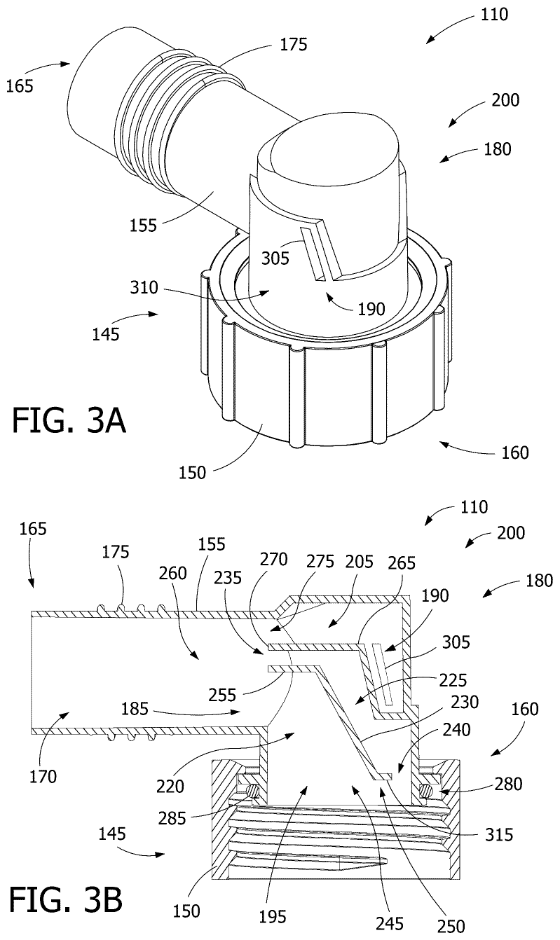

FIG. 3A shows another version of a fluid dispenser 110 of the fluid storage and dispensing system 100 with the fluid dispenser 110 removed from the fluid container 105, and FIG. 3B shows a cross-sectional representation of the version of the fluid dispenser 110 of FIG. 3A. In the version of FIG. 3A, the one or more inlets 190 of the venting system 180 of the fluid dispenser 110 comprise one or more side openings 305 on a side surface 310 of the dispenser body 155, such as a left side surface, as shown, and/or a right side surface as seen in FIG. 3B. The one or more side openings 305 allows air to pass through the side surface 310 in a direction that is orthogonal to the direction of flow of fluid through the dispenser passageway 170. The orthogonal arrangement helps to prevent or reduce the leakage out the side opening 305 of fluid that might find its way into the air chamber 205. By orthogonal it is meant that the air passes generally at an angle that is at least partially orthogonal or offset in relation to a general direction of flow of liquid through the dispenser passageway 170 and/or that is at least partially aligned with an axis that is parallel to an axis of rotation of the pouring tilt of the fluid storage and dispensing system 100. Also in the version of FIGS. 3A and 3B, the fluid channel dividing end 250 of the channel barrier member 230 can be provided with a blocking member 315 which may be positioned forward of the air channel outlet 240 in a manner where it helps to block the passage of fluid from the fluid container 105 from entering the air channel outlet 240 and/or helps to direct the fluid from the fluid container 105 towards the first channel 220 during the dispensing process. The length of the fluid blocking member 250 can also be selected so as to reduce the size of the opening of the air channel outlet 240 and allow the angle of the channel barrier member 230 to be selected as desired.

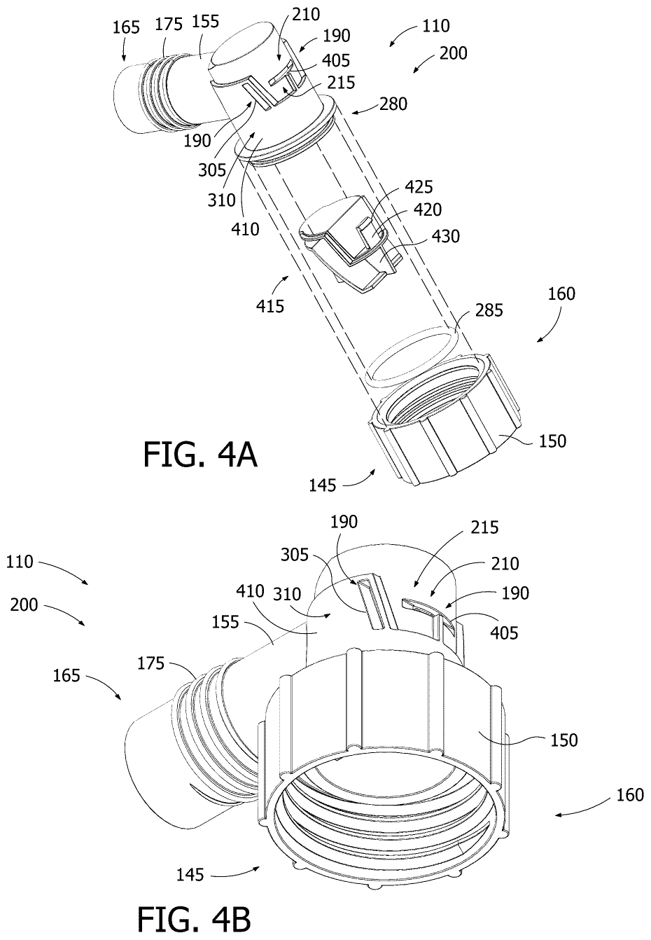

FIG. 4A shows an exploded view of another version of a fluid dispenser 110 of the fluid storage and dispensing system 100 with the fluid dispenser removed from the fluid container 105, and FIG. 4B shows the version of FIG. 4A assembled. The version of FIGS. 4A and 4B is similar to the version of FIGS. 3A and 3B, but with one or more additional features. For example, the one or more inlets 190 of the version of FIGS. 4A and 4B includes both a rear opening 210 and one or more side openings 305. The combination of openings allows air to enter the rear opening 305 in a non-orthogonal manner and air to enter the one or more side openings 305 in an orthogonal manner. In the particular version of FIGS. 4A and 4B, the rear opening 210 is in the form of one or more elongated slots 405.

Additionally, in the version of FIGS. 4A and 4B, the counterflow system 195 of the venting system 180 is formed by a cooperative arrangement between an outer shell 410 of the dispenser body 155 and an insert member 415 that is insertable into an interior of the outer shell 410. The insert member 415 includes walls that form and/or cooperate with the interior of the outer shell 410 to form the air chamber 205, the first channel 220, the second channel 225 and the features of those components. The insert member 415 of the version of FIGS. 4A and 4B includes a tab member 420 that includes a latching member 425 that is receivable in at least a portion of the elongated slot 405 in the rear surface 215 of the outer shell 410 to releasably retain the insert member 415 in the outer shell 410. In the particular version of FIGS. 4A and 4B, the elongated slot 405 serves the dual purpose of receiving the tab member 420 and providing a rear opening 210. Alternative, separate openings and/or slots can be provided. The fluid dispenser 110 comprising an outer shell 410 and an insert member 415 of the type shown in FIGS. 4A and 4B provides a fluid dispenser 110 that is more easily manufactured, assembled, cleaned, and/or replaced. Optionally, the insert member 415 can also include a central wall 430 that divides the first channel 220 into a left first channel and a right first channel and/or that divides the second channel 225 into a left second channel and a right second channel. The central wall 430 serves to provide additional strength and rigidity to the insert member 415.

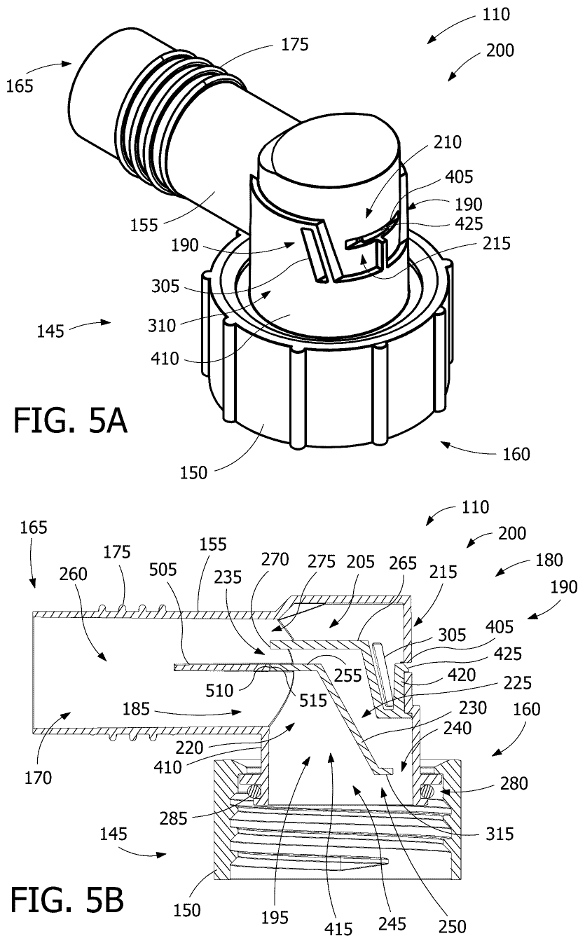

FIGS. 5A and 5B show a perspective view from above and a sectional view from the side, respectfully, of another version of a fluid dispenser 110. The version of FIGS. 5A and 5B is similar to the version of FIGS. 3A and 3B and may, in one version be in the form of an insert member 415 as in FIGS. 4A and 4B. In the version of FIGS. 5A and 5B, an airflow shield 505 can be provided that extends forwardly of or from the flow directing portion 255 of the channel barrier member 230. The airflow shield 505 extends forwardly of the air chamber 205 and helps prevent air from the air chamber 205 from flowing into the first channel 220 and instead encourages the air to flow into the second channel 225. In addition, the airflow shield 505 can help prevent fluid that is leaving the first channel 220 from interfering with the movement of air that is exiting the air chamber 205 and entering the second chamber 225. In the particular version shown in FIG. 5B, the airflow shield 505 is affixed within the outer shell 410 and has a rearward end 510 that engages a forward end 515 of the flow directing portion 255 of the channel barrier member 230 that is part of the insert member 415. Alternatively, the airflow shield 505 can be provided on the insert member 415. In one version, the airflow shield 505 extends forwardly at least 0.25 inches from the forward end of the air chamber shield member 265 and/or the forwardmost portion of the internal opening of the inlet end 160 of the dispenser body. In one version, the airflow shield 505 extends forwardly from about 0.25 inches to about 2 inches, or from about 0.5 inches to about 1.5 inches, or about 1 inch from the forward end of the air chamber shield member 265 and/or the forwardmost portion of the internal opening of the inlet end 160 of the dispenser body.

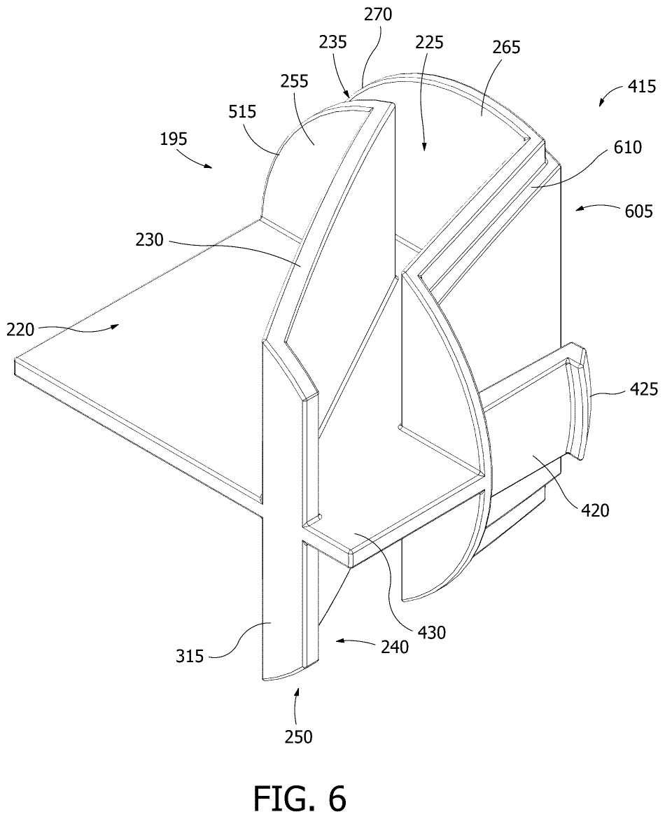

FIG. 6 shows a detailed view of the insert member 415 of the version of FIGS. 4A and 4B. In addition to the features described above, as can be seen in FIG. 6, the insert member 415 includes a keying arrangement 605 that is designed to improve the fit and/or relationship of the insert member 415 in the outer shell 410. For example, in the version shown, the insert member 415 includes one or more shoulder portions 610 that fits within or against a correspondingly shaped portion in the interior of the outer shell 410. The shoulder portion 610 also allows for more surface area contact between the insert member 415 and the outer shell 410, which creates a better liquid-tight seal so fluid is less likely to leak in the air chamber 205.

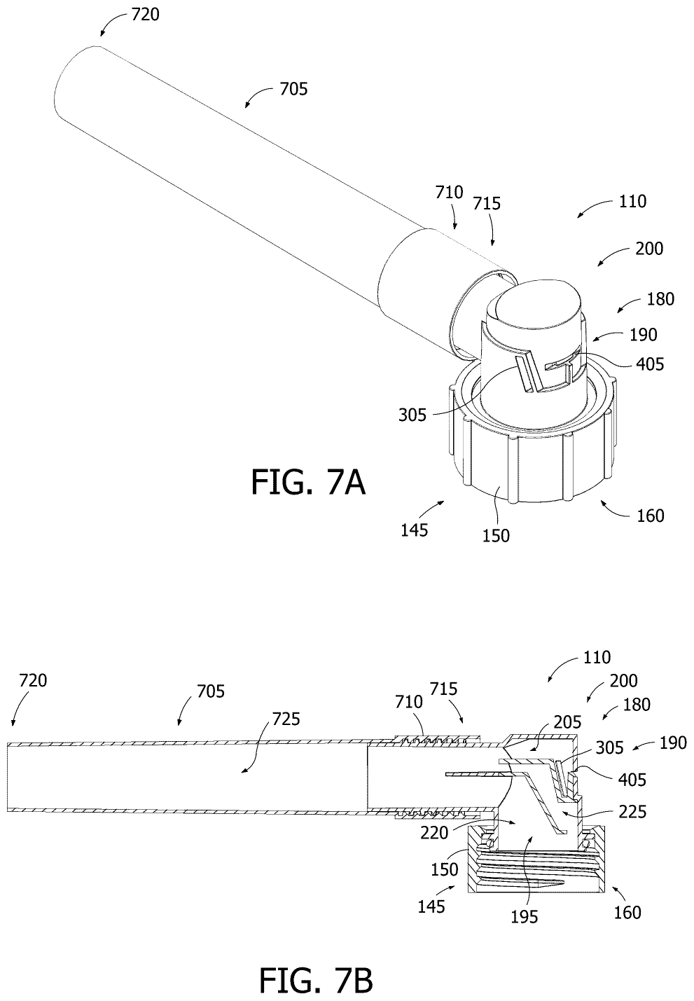

FIGS. 7A and 7B show another version and/or additional features of a fluid dispenser 110 of the fluid storage and dispensing system 100 with the fluid dispenser removed from the fluid container 105. FIGS. 7A and 7B show a fluid dispenser 110 similar to the version of FIGS. 5A and 5B with a nozzle 705 connected to the dispenser body 155. The nozzle 705 includes a dispenser body connector 710 that engages the nozzle connector 175 on the dispenser body 155. The nozzle 705 has a nozzle inlet end 715 that is alignable with the outlet end 165 of the dispenser body 155 and a nozzle outlet end 720. The nozzle 705 thus allows for more precise dispensing of the fluid in the fluid container 105 at a distance spaced from the dispenser body 155. In addition, the nozzle has a nozzle interior space that defines a nozzle reservoir 725 designed and sized to temporarily hold potential backflow fluid that is being poured through the fluid dispenser 110. The nozzle reservoir 725 allows the flow out of the nozzle outlet end 720 to be slower than the flow out of the fluid container 105 with decreased risk of backflow into the venting system 180 and/or the air chamber 205. The nozzle reservoir 725 size can be selected based on the relative flows. In one version, the nozzle reservoir 725 has no internal obstructions so that the fluid can flow freely into and/or through the nozzle reservoir 725 without significant restriction. In one version, the nozzle reservoir 725 can also be sized and shaped to accommodate an initial surge of fluid during the beginning of the pouring process. Sometimes when a fluid pouring process begins, a large surge of fluid can fill channels 220 and 225, and the nozzle reservoir 725 can accommodate that surge.

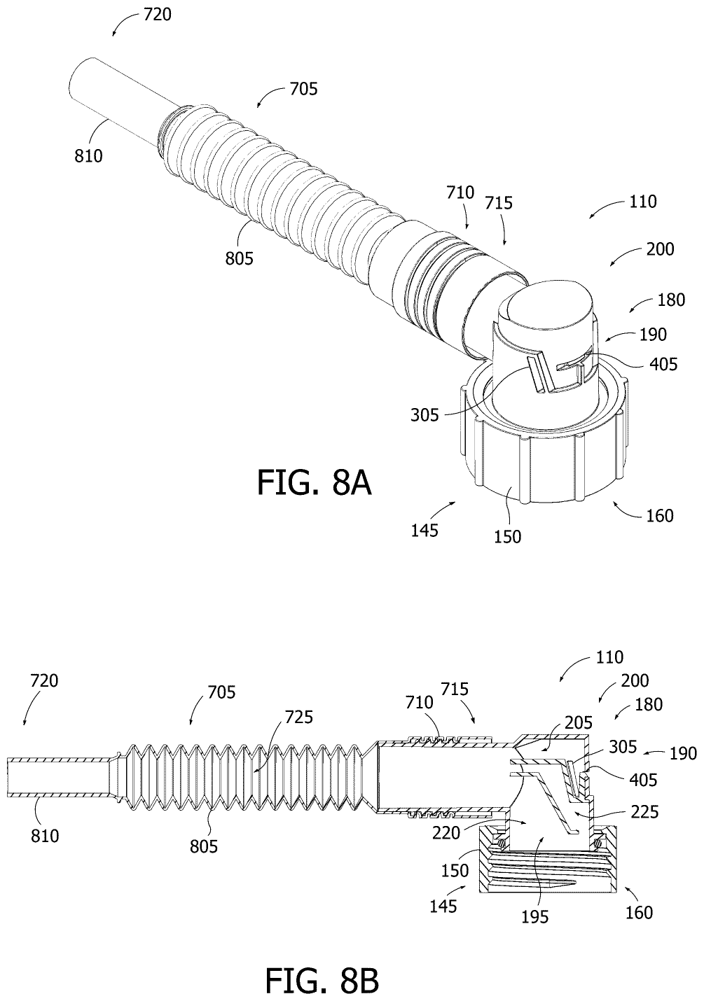

FIGS. 8A and 8B show a version similar to the version of FIGS. 7A and 7B, but in the version of FIGS. 8A and 8B, at least a portion of the nozzle 705 includes a flexible body portion 805 that can be bent or shaped to change the angle of dispensing of the fluid exiting the nozzle outlet end 720. The nozzle 705 of FIGS. 7A and 7B also has a nozzle tip 810. In one version, the nozzle tip 810 has a smaller cross-sectional size than the nozzle reservoir 725. Reducing the size of the nozzle tip 810 can be advantageous because it allows a user to more easily insert the nozzle outlet end 720 into containers with small openings, reducing the risk of spills or wasting fluid. The reduced flow rate of a smaller nozzle top 810 also enables more precise control over the amount of fluid dispensed, making it well suited for applications that require small quantities of fluid.

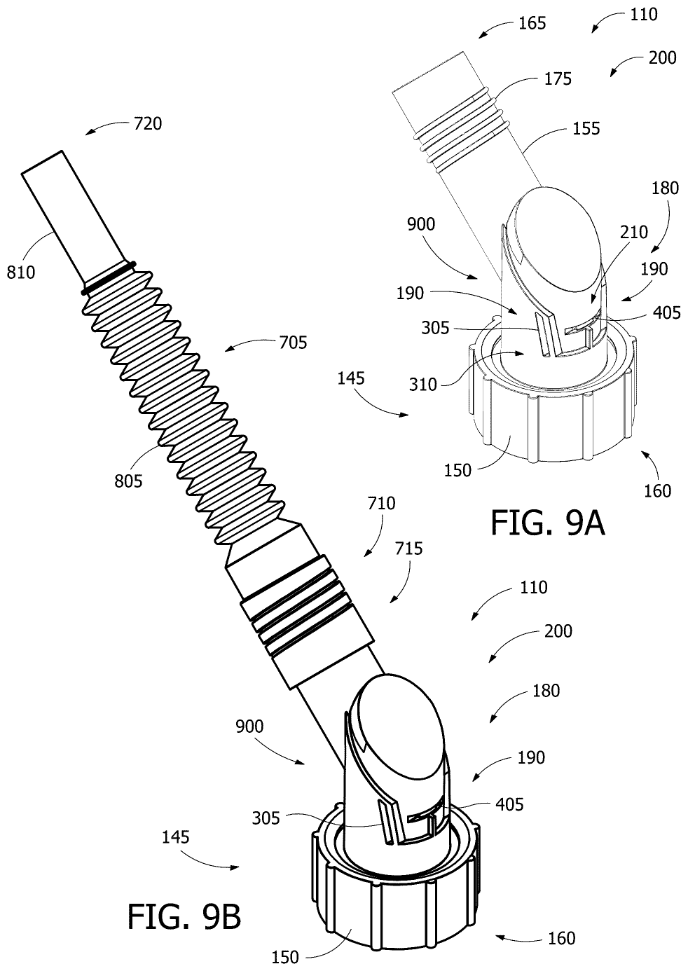

FIG. 9A shows a version similar to FIGS. 5A and 5B. However, whereas in the version of FIGS. 5A and 5B, the outlet end 165 is oriented at angle of about 90 degrees relative to the inlet end 160, in the version of FIG. 9A, the outlet end 165 is oriented at an angle 900 that is other than about 90 degrees. More specifically, in the particular version of FIG. 9A, the outlet end 165 is oriented an angle 900 of from about 90 degrees to about 160 degrees, and in one particular version is about 140 degrees to about 150 degrees, or about 135 degrees. The variation in angles 900 allows the fluid disperser 110 to be better suited to pouring into a particular tank or the like and/or may be a matter of user preference. The version of FIG. 9B is similar to the version of FIG. 9A but with a nozzle 705 attached.

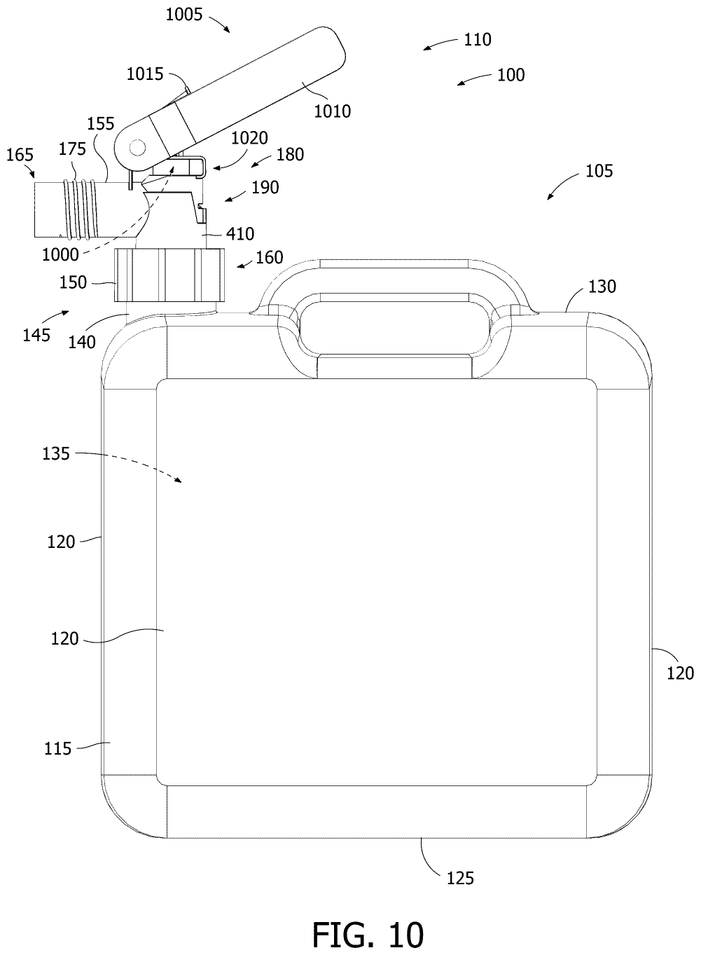

FIGS. 10-21 show another version and/or variations of another version of a fluid storage and dispensing system 100 of the invention. In this version, the fluid storage and dispensing system 100 includes a version of a fluid dispenser 110 in which the fluid dispenser 110 comprises a self-closing valve system 1000. An actuating mechanism 1005 having a handle body 1010 with a support flange 1015 is designed for easy operation and opening of the self-closing valve system 1000. FIG. 10 shows the fluid storage and dispensing system 100 of this version with a fluid dispenser 110 of this version of the invention connected to a fluid container 105, which can be a conventional fluid container 105 and/or a fluid container 105 as disclosed herein. A mounting platform 1020 allows the actuating mechanism 1005 to be operably mounted on the fluid dispenser 110, as will be described.

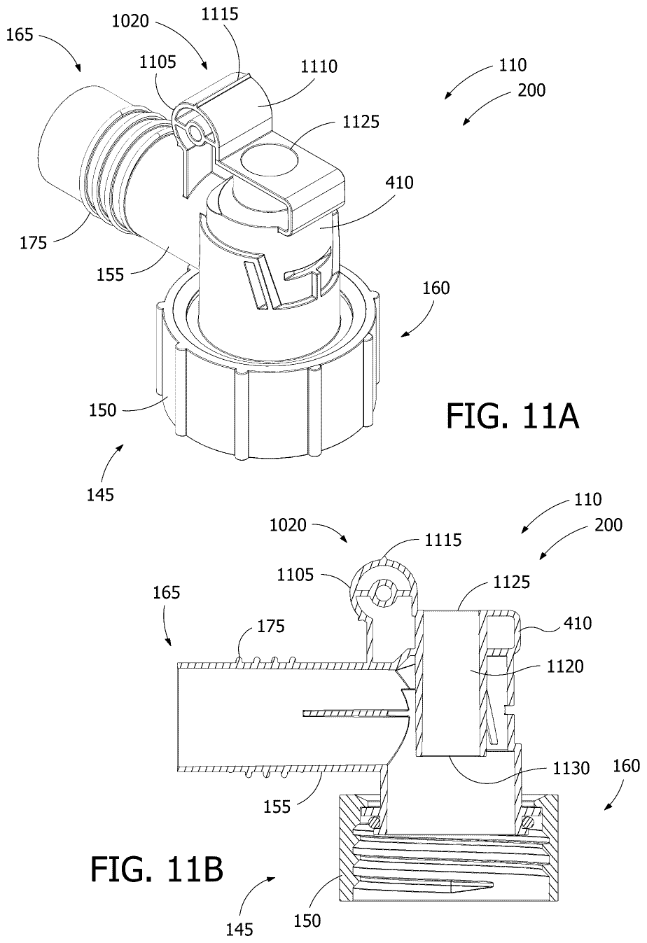

FIG. 11A shows a perspective rear view and FIG. 11B shows a side sectional view of a dispenser assembly 200 of this version of the fluid storage and dispensing system 100. In this version of the dispenser assembly 200, the outer shell 410 of the fluid dispenser 110 serves as an enclosure for the components of the fluid dispenser 110 and for at least a portion of the self-closing valve system 1000. The mounting platform 1020 is provided on or as part of the outer shell 410. The mounting platform 1020 includes a rotational mounting member 1105 for rotationally mounting and supporting the handle body 1010 of the actuating mechanism 1005. The rotational mounting member 1105 includes a rotational surface 1110 that can help to guide the handle body 1010. One or more protrusions 1115 may be provided on the rotational surface 1110, as will be described. The outer shell 410 has an enclosed interior 1120 with a top open end 1125 and a bottom open end 1130, allowing the self-closing valve system 1000 (not shown in FIG. 11A and FIG. 11B for clarity) to be inserted and at least partially contained within the fluid dispenser 110. The self-closing valve system 1000 is inserted into the bottom open end 1130 of the enclosed interior 1120 where it is securely seated and housed, as will be described.

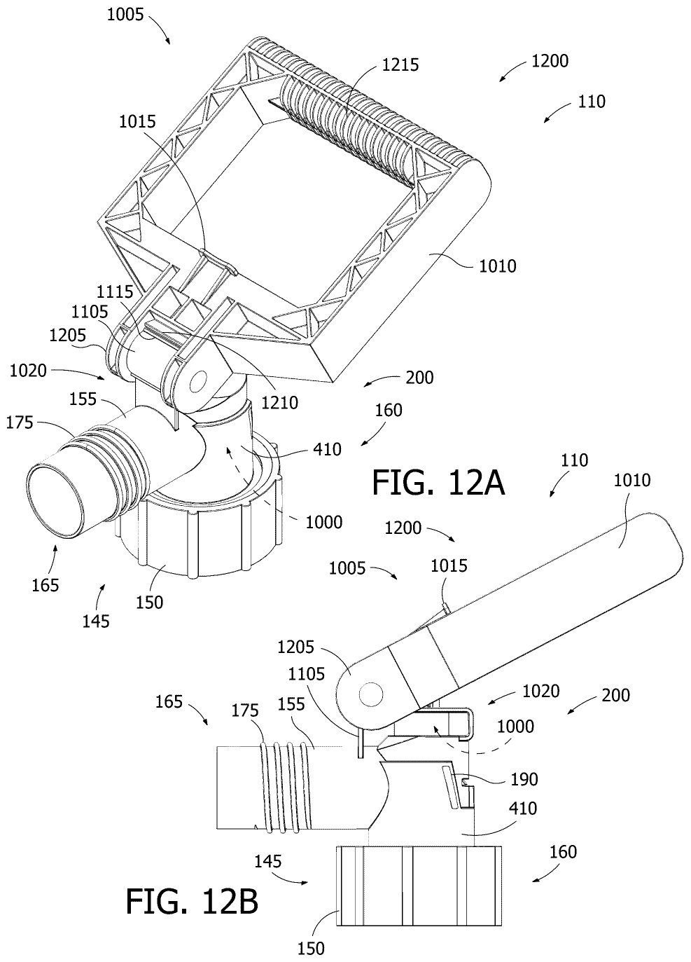

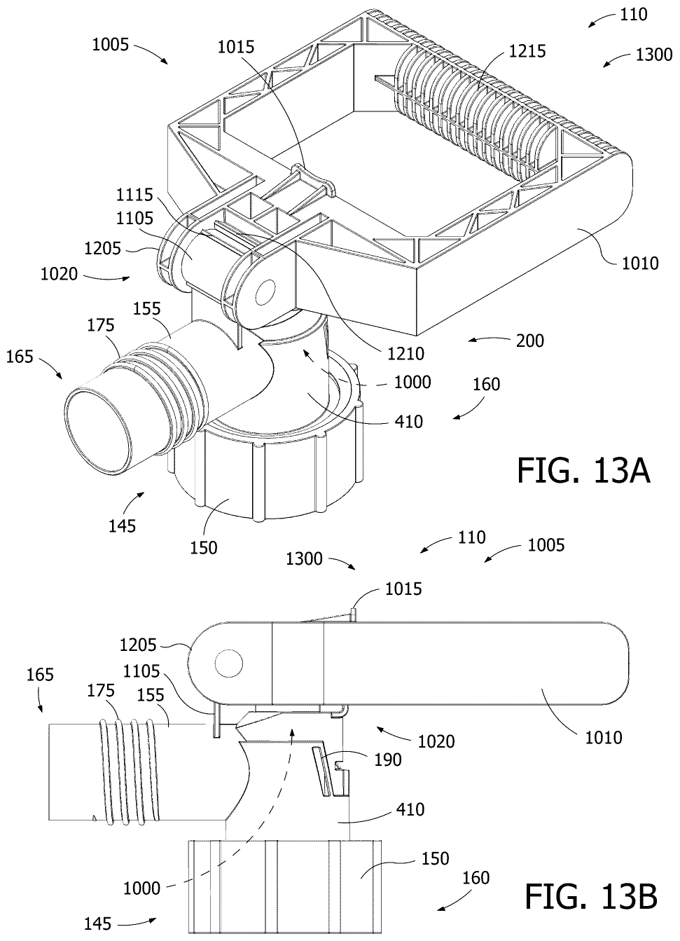

FIG. 12A is a perspective front view showing the actuating mechanism 1005 mounted on the mounting platform 1020 of the fluid dispenser 110, and FIG. 12B is a schematic side view of the same. In FIGS. 12A and 12B, the actuating mechanism 1005 in a closed position 1200 which is associated with a closed position of the self-closing valve system 1000 in operation, as will be explained. FIGS. 13A and 13B show the same views as in FIGS. 12A and 12B with the actuating mechanism moved to an open position 1300 associated with an open position of the self-closing valve system 1000 in operation, as will also be explained. The self-closing valve system 1000 is contained within the enclosed interior 1120 in a position where it can be acted on by the actuating mechanism 1005. A rotational mount receiving portion 1205 of the handle body 1010 receives the rotational mounting member 1105 of the mounting platform 1020 of the fluid dispenser 110 in a manner that allows the actuating mechanism 1005 to rotate about the mounting platform 1020 from at least the closed position 1200 as shown in FIGS. 12A and 12B to the open position 1300 as shown in FIGS. 13A and 13B. As can also be seen, the handle body 1010 can include a protrusion engaging member 1210 that engages the protrusion 1115 on the rotational surface 1110 of the rotational mounting member 1105 to encourage the actuating member 1005 to remain in the closed position 1200 until and opening force is applied and/or to give a tactile indication of the position of the actuating member 1005. A gripping surface 1215 can also be provided on the handle body 1010 to help facilitate a user's gripping and manipulation of the handle body 1010.

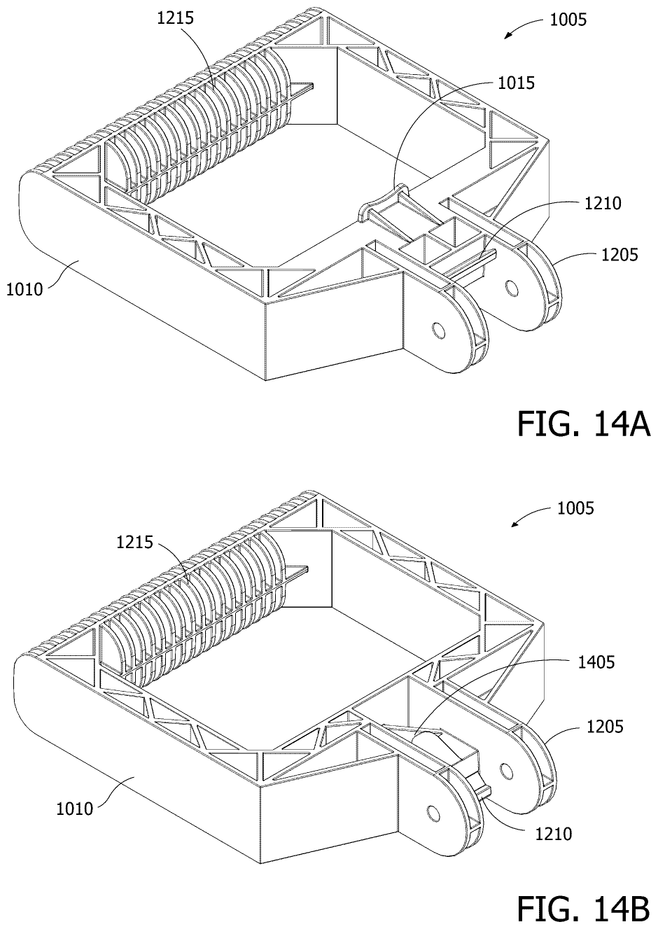

FIGS. 14A and 14B show front and rear sides, respectively, of the detached handle body 1010 of the actuating mechanism 1005. In addition to the parts discussed above, as can be seen in FIG. 14B, the rear side of the handle body 1010 includes an actuating mechanism cam surface 1405 that is adapted to contact the self-closing valve system 1000 when the actuating mechanism 1005 is moved to the open position 1300 to cause the self-closing valve system 1000 to open, as will be discussed.

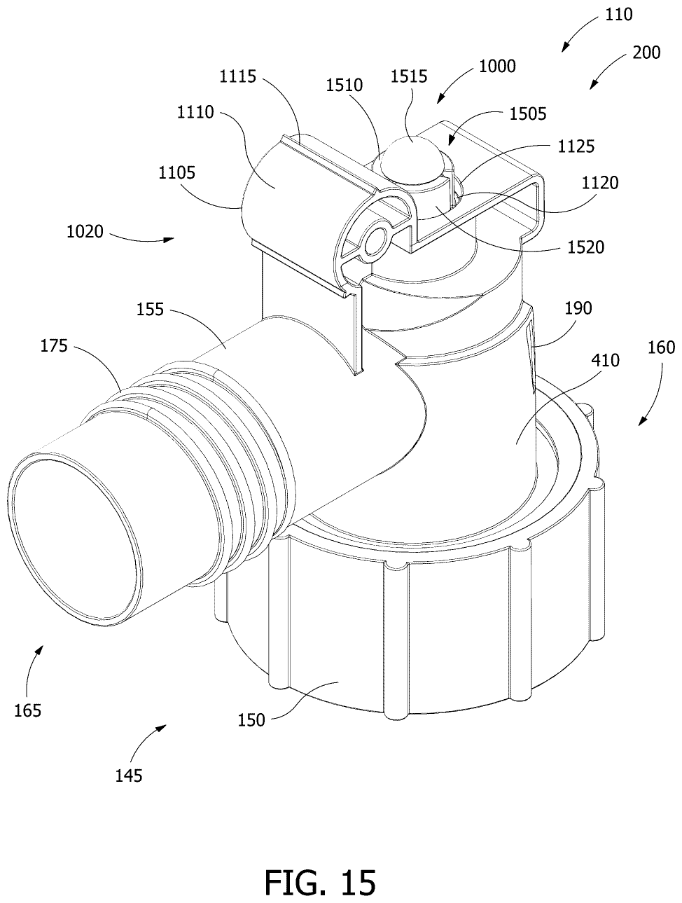

FIG. 15 is a perspective view from the front of a version of the dispenser assembly 200 in accordance with the fluid storage and dispensing system 100 with the dispenser actuating mechanism removed for clarity and with the self-closing valve system 1000 positioned in the shell enclosed interior 1120. A valve member 1505 of the self-closing valve system 1000 is positioned within the enclosed interior 1120 so that a top portion 1510 of the valve member 1505 extends through and above the top open end 1125 of the enclosed interior 1120. The top portion 1510 includes a valve member contact surface 1515 that can be contacted by the actuating member cam surface 1405. In the particular version shown, the actuating member cam surface 1405 contacts and depresses the valve member contact surface 1515 when the actuating member 1005 is moved to the open position 1300. As the actuating mechanism 1005 pivots downward from its upper closed position 1200 to its lower open position 1300, it opens the self-closing valve system 1000, allowing the fluid to flow out of the fluid container 105 when needed. Conversely, as the actuating mechanism 1005 is returned from its open position 1300 to the closed position 1200, the self-closing valve system 1000 closes, effectively shutting off the fluid flow and preventing any leakage or spillage. The self-closing valve system 1000 can also optionally include a valve collar 1520, as seen in FIG. 15.

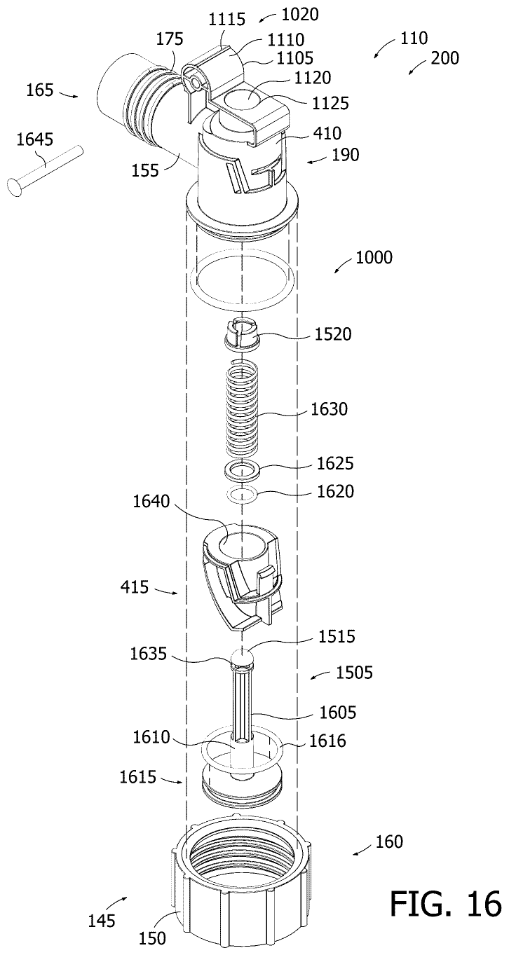

FIG. 16 is a schematic exploded perspective view of the dispenser assembly 200 of FIG. 15 with the dispenser actuating mechanism removed and showing the components of the self-closing valve system 1000. The valve member 1505 includes a valve stem 1605 that extends from the contact surface 1515 to a cylindrical surface 1610 connected to a sealing member 1615, which can include an O-ring 1616 or the like. The valve member 1505 can be assembled with a valve collar 1520, as mentioned above, to position the insert member 415, valve member 1505, an O-ring 1620, a washer 1625, and a spring 1630, in a predetermined relationship, as shown. The valve collar 1520 includes snap-fit tabs that mate with a recessed area 1635 on the valve member 1505 when assembled. The valve member 1505 allows for smooth rotation and engagement with the cam surface 1405 on the actuating mechanism 1005. The washer 1625 is positioned between the spring 1630 and the O-ring 1620. This protective design ensures that the O-ring 1620 remains intact and functional by cushioning any potential impact from the spring 1630. The washer 1625 absorbs force exerted by the spring 1630, thereby preventing damage to the O-ring 1620. The O-ring 1620 seals an internal chamber and prevents leaks within the self-closing valve system 1000. The spring 1630 biases the valve member 1505 towards its closed position ensuring that it remains in this state when not in use or when there is not a force applied that overcomes the bias force. The washer 1625 positioned between the spring 1630 and O-ring 1620 serves to protect the O-ring 1620 from damage caused by the spring 1630. The insert member 415 includes an internal chamber 1640 that receives the valve member 1505.

The rotational mount 1205 of the handle body 1010 is designed for attachment to mounting platform 1020 on or attached to the outer shell 410 on the fluid dispenser 110. A rivet 1645 passes through the rotational mount 1205 to attach the handle body 1010 to the rotational mounting member 1105 of the mounting platform 1020 to create a hinge-type of rotational connection between the mounting member 1020 and the handle body 1010. In the particular version shown, one end of the rivet 1645 is inserted into an apertured section of the rotational mount 1205 of the handle body 1010, passes through corresponding apertures in the rotational mounting member 1105 on the outer shell 410, and finally passes through another aperture on the handle 1010. This secure attachment method provides additional stability to the handle body 1010 and prevents it from detaching during use or storage.

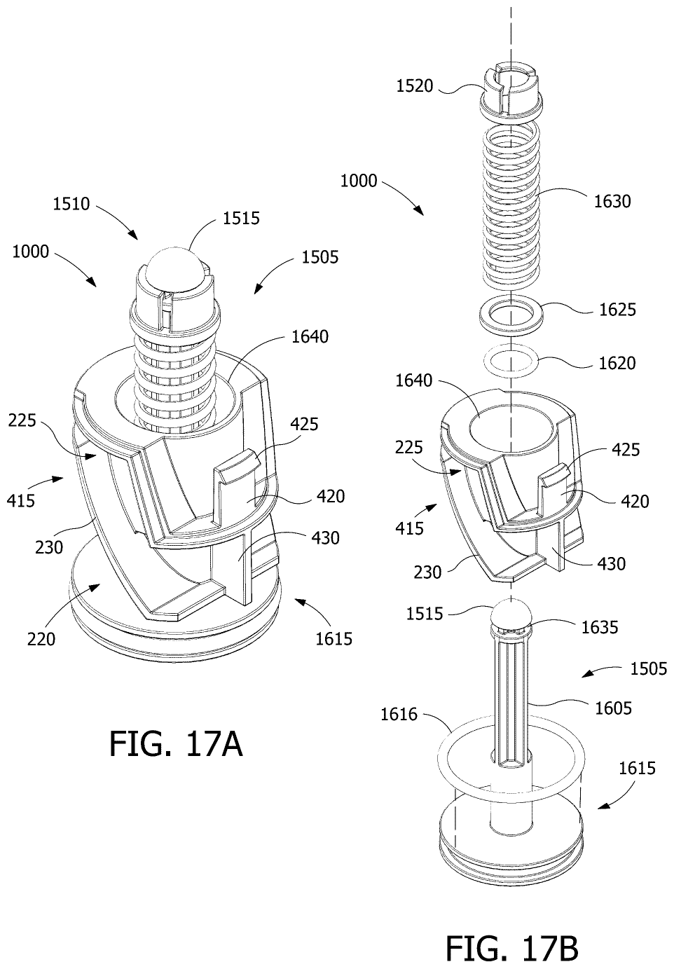

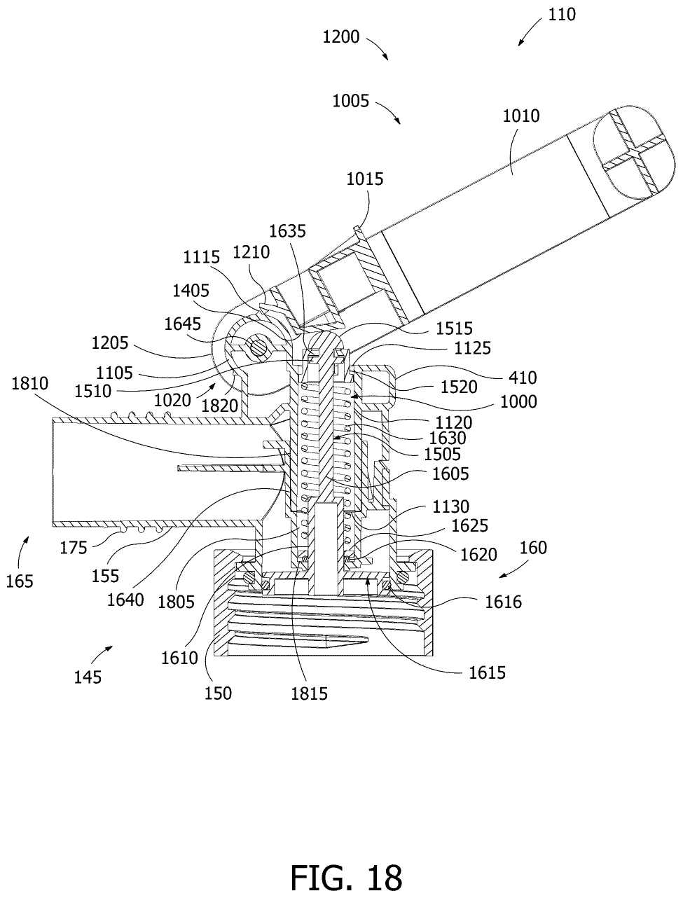

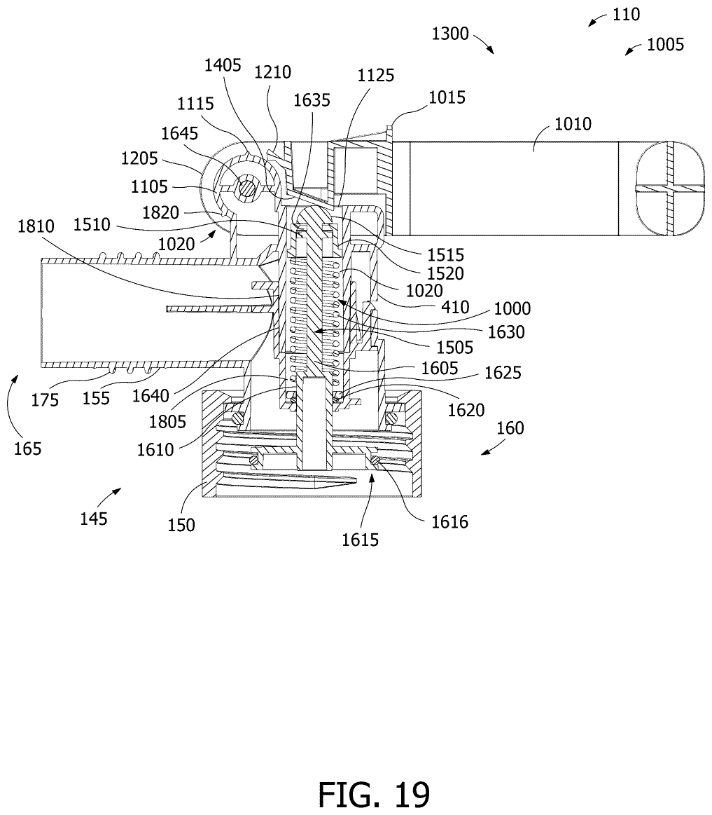

FIGS. 17A and 17B show an assembled and exploded views, respectively, of the valve member 1505 of the self-closing valve system 1000 received within the internal chamber 1640 of the insert member 415. As can be seen in in FIGS. 17A and 17B, the insert member 415 with a first channel 220 and a second channel 225 houses the self-closing valve system 1000 components. FIG. 18 is a sectional side view of a version of a dispenser 110 of an assembled fluid storage and dispensing system 100 in accordance with the version of FIG. 10 in a closed position 1200, and FIG. 19 is a sectional side view in an open position 1300. The assembly process for the self-closing valve system 1000 begins by positioning the valve member 1505 within an internal chamber 1640 of the insert member 415. The internal chamber 1640 include a lower internal chamber portion 1805 and an upper internal chamber portion 1810 in the insert member 415, as seen in FIGS. 18 and 19. The O-ring 1620 is seated on a floor 1815 of the lower internal chamber portion 1805, creating a secure seal between the cylindrical surface 1610 of the valve member 1505 and the interior walls of the lower internal chamber portion 1805. The spring 1630 and washer 1625 are then positioned above the O-ring 1620, with the valve collar 1520 securing them in place. The washer 1625 is seated between the spring 1630 and the O-ring 1620 to absorb any potential impact from the spring 1630, protecting the O-ring 1620 from damage. The snap-fit tabs on the valve collar 1520 mate with the recessed area 1635 on the valve member 1505, ensuring a secure connection.

In use, as a user manipulates the handle body 1010 of the actuating mechanism 1005 from the closed position 1200 to the open position 1300, the actuating member cam surface 1405 of the handle body 1010 serves to open the self-closing valve system 1000 and move the valve member 1505 from a closed position to an open position, respectively. As the user pivots the handle body 1010 downward from its upper closed position 1200 to its lower open position 1300, the actuating member cam surface 1405 engages with the contact surface 1515 of the top portion 1510 of the valve member 1505, which in the version shown is a spherical surface. This engagement causes the valve member 1505 to move linearly within its enclosed interior 1120 to the valve member open position, opening the fluid path between the inlet end 160 and the outlet end 165 of the dispenser 110. As a result, fluid can flow from the inlet end 160 through the outer shell 410 and out of the outlet end 165, allowing the user to dispense a controlled amount of fluid. As the user releases downward pressure on the handle body 1010, the actuating member cam surface 1405 disengages from mating with the contact surface 1515 on the valve member 1505, allowing the spring 1630 to return the valve member 1505 to its closed position. This motion closes the fluid path between the inlet end 160 and the outlet end 165, preventing accidental fluid dispensing. When the actuating member 1005 is in the closed position 1200, the valve member 1505 is in a closed position and fluid flow through the self-closing valve system 1000 is prevented, maintaining a secure seal.

In this version of the fluid storage and dispensing system 100, the actuating mechanism 1005 serves as a simple and intuitive way for a user to activate the self-closing valve system 1000. The handle 1010 requires minimal effort to pivot downward from its closed position 1200 to its open position 1300 when opening the self-closing valve system 1000. This design allows a user to easily open the fluid dispenser 110 and dispense fluid while supporting a heavy fluid container 105 containing fluid. The actuating mechanism 1005 includes multiple features designed to enhance user experience and facilitate storage. For example, the protrusion engagement member 1210 of the handle body 1010 can be in the form of a snap-fit tab that engages with one or more protrusions 1115 on the rotational mounting member 1105 of the mounting platform 1020 on the outer shell 410. The protrusion 1115 creates a secure fit between the handle body 1010 and the fluid dispenser 110, thereby preventing the handle body 1010 from pivoting downwardly when the fluid storage and dispensing system 100 is tilted. This design provides an advantage in terms of usability. The secure engagement of the handle body 1010 to the fluid dispenser 110 prevents it from getting out of position when tilting or maneuvering, allowing for more efficient and comfortable use of the fluid storage and dispensing system 100.

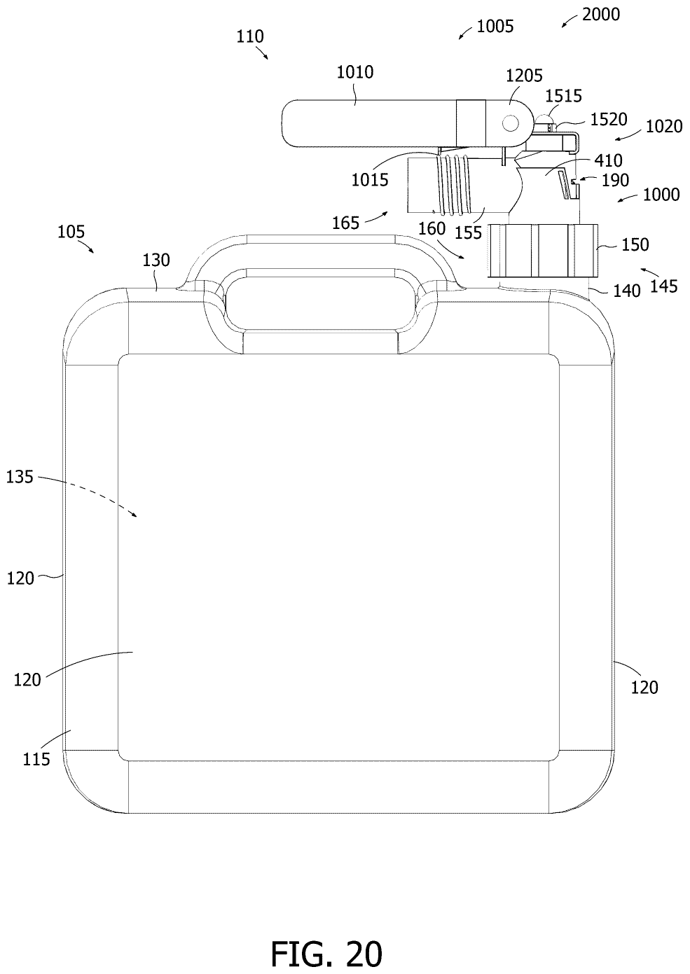

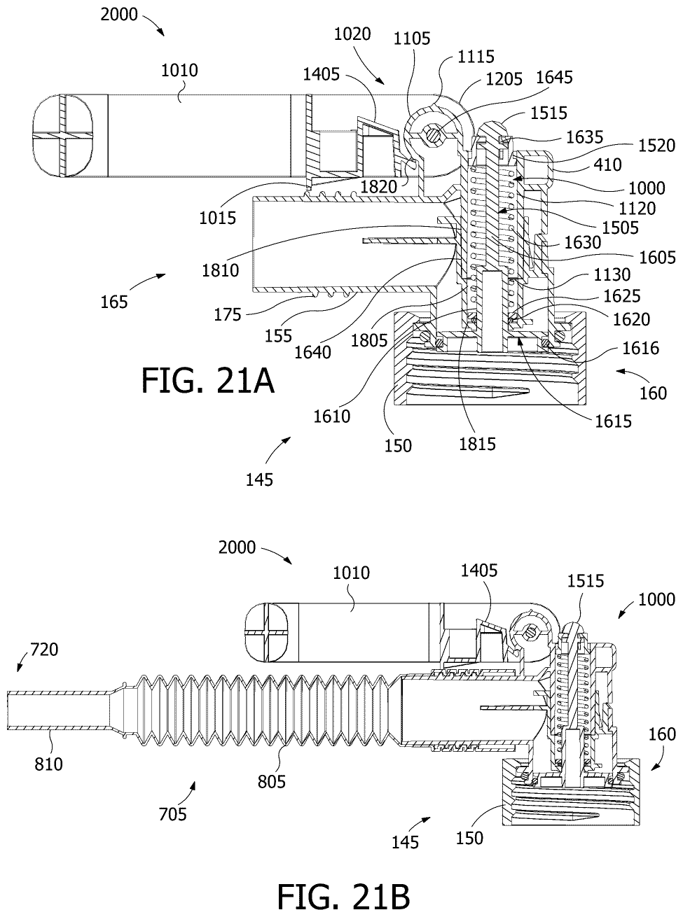

FIGS. 20, 21A, and 21B show the actuating mechanism 1005 in an optional forward storage position 2000. In addition to the protrusions 1115 for maintaining the handle member 1010 in the closed position 1200, the rotational surface 1110 may include a secondary protrusion 1820, as seen in FIG. 18, that is positioned to engage with the protrusion engaging member 1210 of the handle body 1010 when the handle body 1010 is pivoted to a certain angle, such as a 90-degree angle. The secondary protrusion 1820 provides a secure hold for the handle body 1010 in the storage position 2000, as shown in FIGS. 20, 21A, and 22B. The support flange 1015 is provided on the top side of the handle body 1010. The support flange 1015 rests against the dispenser body 155 when the handle body 1010 is pivoted to its storage position 2000. In this position, the actuating member cam surface 1405 does not contact the top portion contact surface 1515. The support flange 1015 can be designed in various shapes and sizes to fit snugly with the dispenser body 155 when the fluid dispenser 110 is in its storage position 2000. One version of the support flange 1015 has a curved shape that matches the contours of the dispenser body 155, providing a secure and stable resting surface for the handle body 1010. The support flange 1015 provides structural support by transferring the weight and pressure to the dispenser body 155, thereby reducing stress on the handle body 1010. When stacking multiple fluid storage and dispensing system 100 units on top of each other in their storage position, the weight and pressure of the units above can cause stress and potential damage to the handle body 1010. To prevent this, the support flange 1015 of each handle body 1010 provides structural support by transferring the weight and pressure to the dispenser body 155, thereby reducing stress on the handle body 1010.

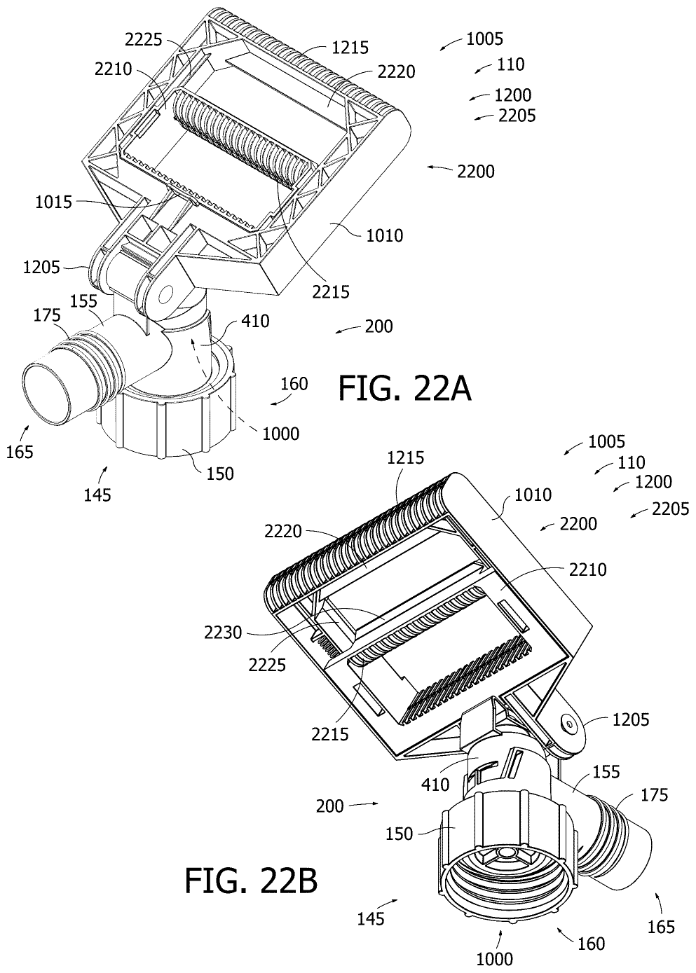

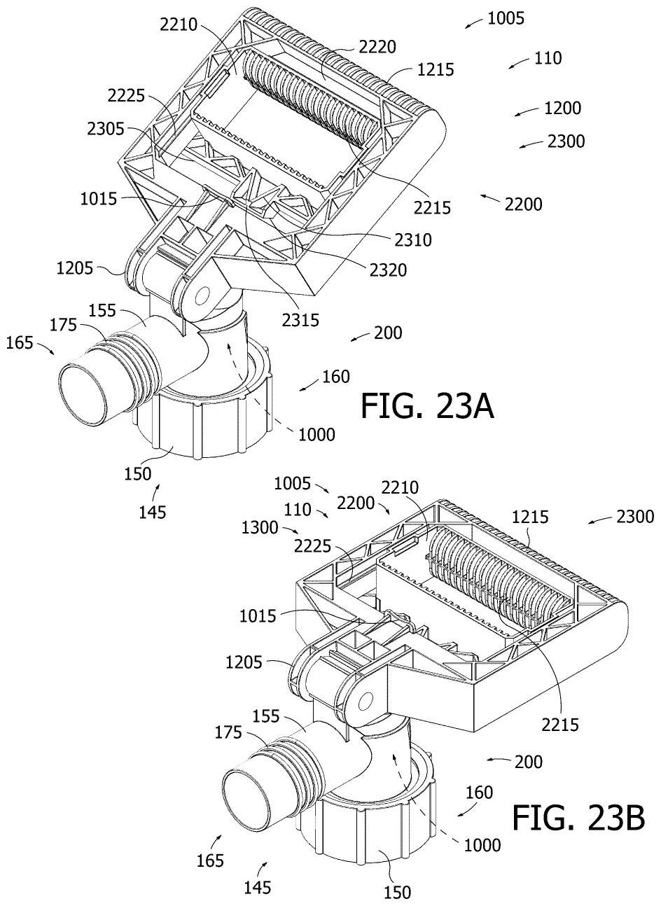

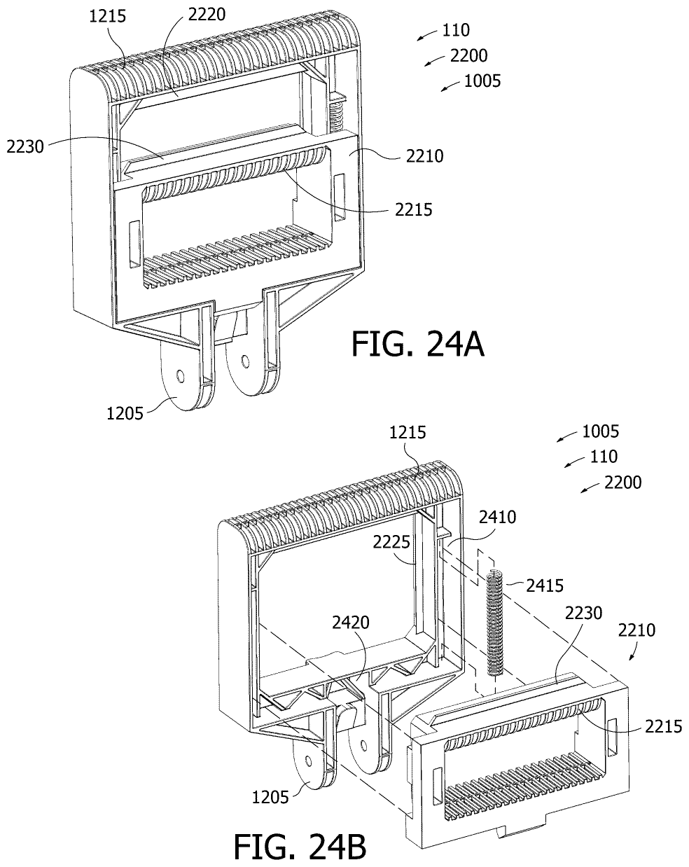

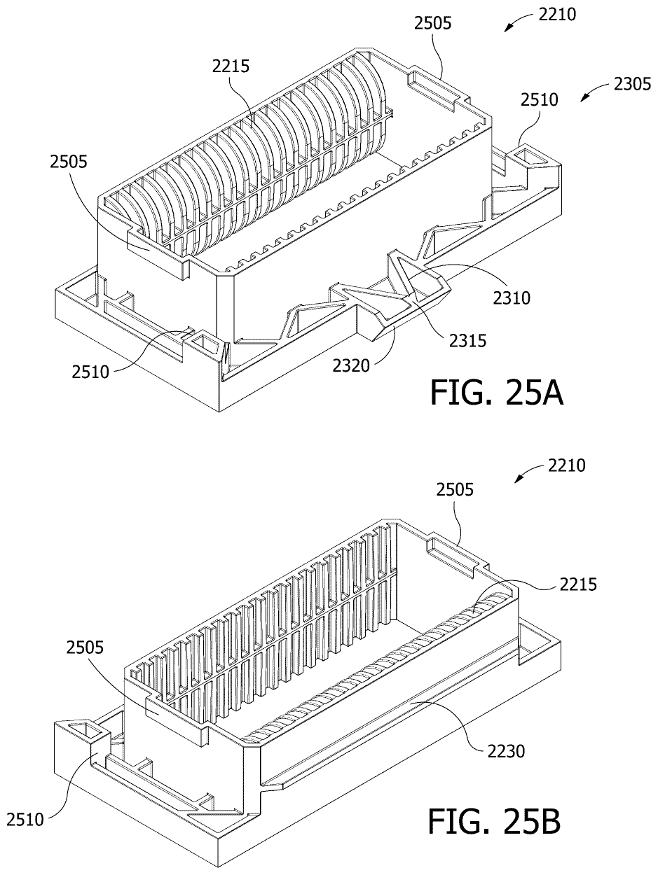

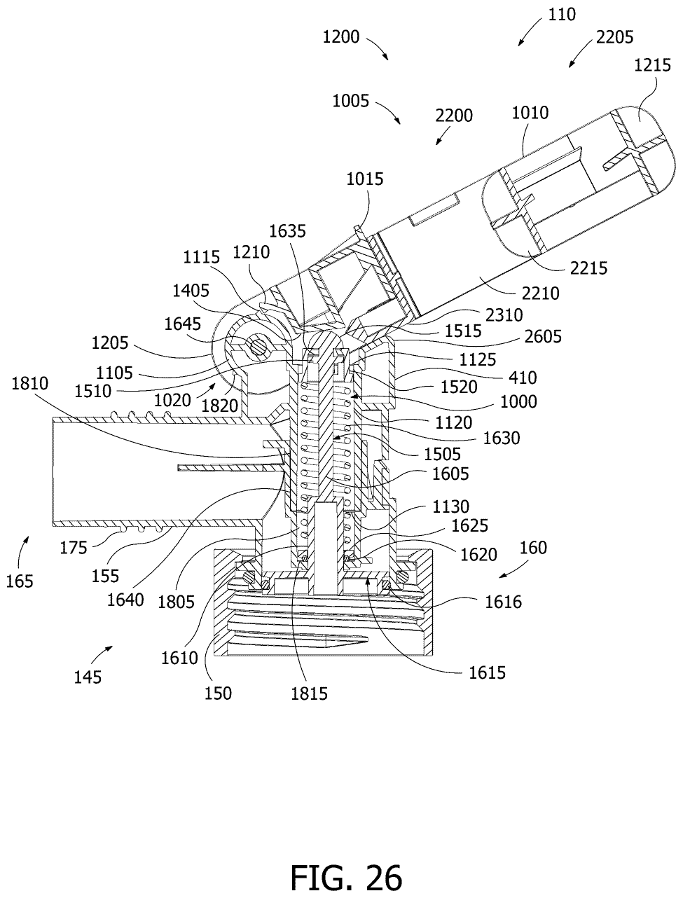

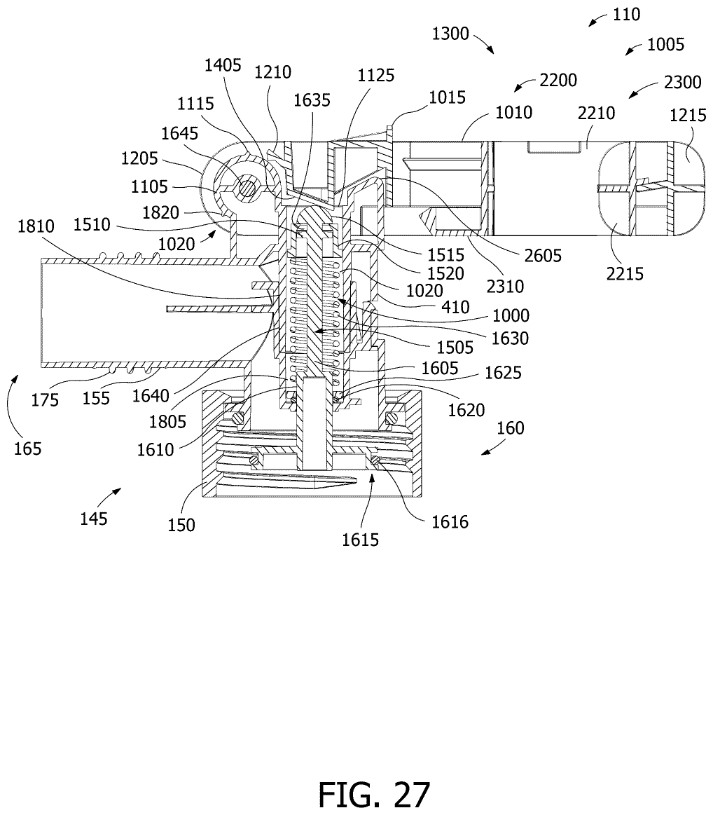

FIGS. 22 through 27 show another version of a fluid storage and dispensing system 100 of the invention. The version of FIGS. 22 through 27 includes a child-resistant mechanism 2200. FIG. 22A is a schematic perspective view from above, front, and side of a dispenser 110 with an actuating mechanism 1005 in a locked configuration 2205 and a closed position 1200. FIG. 22B is a schematic perspective view from below, rear, and side of a dispenser 110 with the actuating mechanism 1005 in a locked configuration 2205 and a closed position 1200. FIG. 23A is a schematic perspective view from above, front, and side of the dispenser 110 with an actuating mechanism 1005 in an unlocked configuration 2300 and a closed position 1200. FIG. 23B is a schematic perspective view from above, front, and side of the dispenser 110 with an actuating mechanism 1005 in an unlocked configuration 2300 and an open position 1300. FIG. 24A is a schematic detailed view of the interior of a version of a dispenser actuating mechanism 1005 with a child-resistant mechanism 2200. FIG. 24B is a schematic exploded view of the dispenser actuating mechanism of FIG. 24A. FIG. 25A is a perspective view from the bottom of the rear of the locking member 2210, and FIG. 25B is a perspective view from the top of the rear of the locking member 2210. FIG. 26 is a schematic sectional side view of a dispenser 110 with a child-resistant mechanism 2200 in a locked configuration 2205 and with the actuating mechanism 1005 in a closed position 1200. FIG. 27 is a schematic sectional side view of a dispenser 110 with a child-resistant mechanism 2200 in an unlocked configuration 2300 and with the actuating mechanism 1005 in an open position 1300.

As shown in FIGS. 22 through 27, the version of a dispenser 110 having an actuating mechanism 1005 with a child-resistant mechanism 2200 of FIGS. 22 through 27 comprises an actuating mechanism 1005 with a handle body 1010 that encloses a locking member 2210 that slides along or within the handle body 1010. The locking member 2210 includes four sides, including a top side with a locking member grip 2215. In the version shown, the locking member grip 2215 is a half grip that completes a half grip that makes up the gripping surface 1215 of the handle body 1010. The locking member 2210 has left and right sides in engagement with the handle body 1010, allowing for sliding motion between the two components. When the locking member 2210 is moved towards a handle grip member 1215, half of a grip on the locking member grip 2215 combines with the half of a grip on the handle grip member 1215 to form a full grip handle. The combination creates a comfortable and secure grip. The sliding motion between the two components is facilitated by snap-fit features 2505 on the outside of the left and right sides of the lock 1205 that engage with a slide track 2225, such as protrusion or the like, on an interior surface of the handle body 1010.

The handle body 1010 has a handle grip member 1215 at one end, with two protrusions that make up the slide track 2225 located on the inside of its left and right sides of the handle body 1010. These protrusions of the slide track 2225 run from the handle grip member 1215 to the handle back member. The snap-fit features 2505 on the locking member 2210 are designed to securely engage with these protrusions of the slide track 2225 when assembled. As the locking member 2210 slides or moves towards or away from the handle grip member 1215, it slides along the corresponding protrusions of the slide track 2225 on the inside of the handle body 1010. This allows for efficient sliding motion while maintaining a connection between the lock member 2210 and the handle body 1010.

A handle body tab 2220 on the inside of the handle body 1010 is located on or near the handle grip member 1215. The locking member 2210 has an upwardly extending locking member tab 2230 opposite the locking member grip 2215. When the locking member 2210 is moved or slid towards the handle grip member 1215, the handle body tab 2220 and the locking member tab 2230 are positioned in an orientation where the locking member tab 2230 is above the handle body tab 2220. This design prevents the locking member 2210 from being pushed outward, thereby helping to maintain engagement between the snap-fit features 2505 of the locking member 2210 and the corresponding slide track 2225 with protrusions on the handle body 1010. The locking member 2210 has flared sections 2305 extending outward on the left, right, and back members. When assembled with on the handle body 1010, these flared sections 2305 are recessed within the handle body 1010. Two engagement tabs 2510 are located on the flared sections with one on the left member and one on the right member. Each engagement tab 2510 protrudes into a separate compartment 2410 within its corresponding member. A spring 2415 is positioned close to the engagement tab on the locking member 2210 in both or either compartment 2410. The compartment 2410 can be designed to occupy any part of the members' length, extending fully along them or shorter.

The presence of the spring 2415 in one or more compartment 2410 enables the automatic return of the locking member 2210 to its locked configuration 2205 position when released by the user. When the user pulls the locking member 2210 towards the handle grip member 1215, the spring 2415 compresses, allowing the locking member 2210 to move closer to the handle grip member 1215. Conversely, as the user releases the locking member 2210, the compressed spring 2415 applies force against a face on the engagement tab 2510, forcing the locking member 2210 back into its retracted position or locked configuration 2205 away from the handle grip member 1215 and facilitating a self-returning or automatic reset mechanism.

On the rear side of the locking member 2210, a stop bracket 2310 is located at the distal end of the flared section 2305. When the locking member 2210 is in its retracted position or its locked configuration 2205, the stop bracket 2310 moves into a compartment 2420 on the handle body 1010 and is positioned above a protruded section 2605 on the outer shell 410. When in this position, the stop bracket 2310 acts as a mechanical stop that prevents the handle body 1010 from pivoting downward from the closed position 1200 to the open position 1300. The top surface of the stop bracket 2310 has a chamfer 2315 on its distal edge that comes into contact with the interior surface of the compartment 2420 when the locking member 2210 moves into the retracted position or locked configuration 2205. This chamfer 2315 facilitates smooth movement between the stop bracket 2310 and the handle body 1010, reducing the likelihood of the stop bracket 2310 becoming caught during the insertion process. The bottom surface of the stop bracket 1250 has a chamfer 2320 on its distal edge that comes into contact with the protruded section 2605 on the outer shell 410 when the locking member 2210 moves into the retracted position. This chamfer 2320 helps to prevent the stop bracket 2310 from becoming caught on the protruded section 2605 during the retraction process.

When the user attempts to open the fluid dispenser 110 with the locking member 2210 in its retracted position or locked configuration 2205, the position of the stop bracket 2310 above the protruded section 2605 on the outer shell 410 effectively blocks the pivot range of the handle body 1010. The self-closing valve system 1000 remains closed in this state, maintaining a secure seal on the fluid dispenser 110. However, when the user pulls the locking member 2210 towards the handle grip member 1215, the stop bracket 2310 moves away from being positioned above the protruded section 2605 on the outer shell 410. This movement clears the path for the handle body 1010 to pivot downward to the open position 1300. As the handle body 1010 pivots downward, it engages with the self-closing valve system 1000 and opens it, allowing fluid to flow out of the fluid container 105 when needed. Thus, the interaction between the stop bracket 2310, the locking member 2210, and the handle body 1010 ensures that the self-closing valve system 1000 can only be opened when the user intentionally pulls the locking member 2210 towards the handle grip member 1215, thereby maintaining a secure seal on the fluid dispenser 110 assembly until it is intended to be activated.

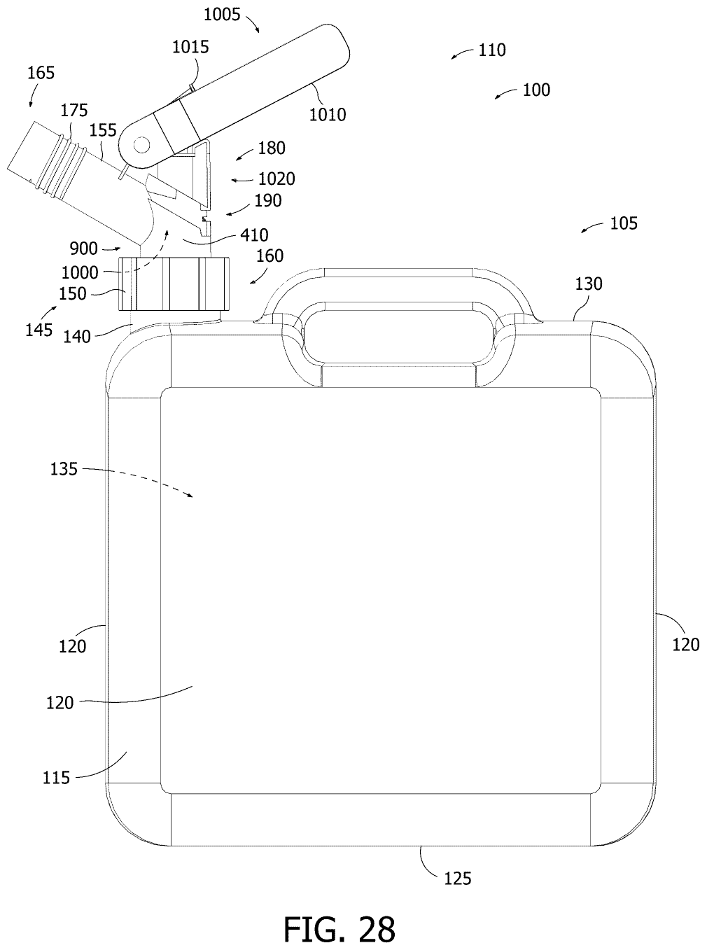

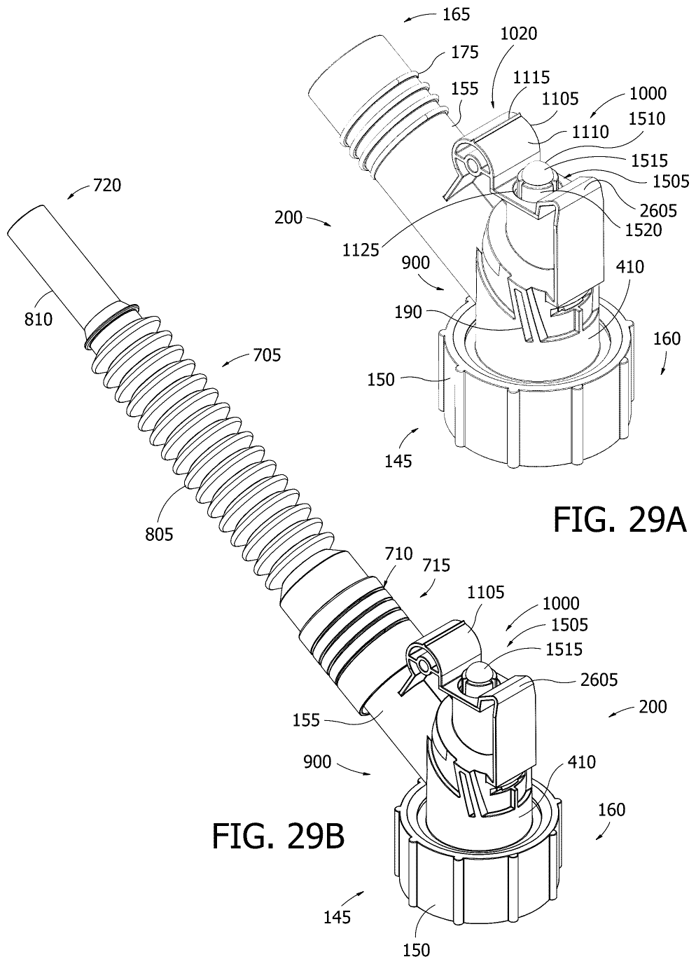

FIGS. 28, 29A, and 29B show another version of a fluid storage and dispensing system 100 of the invention. FIG. 29A is a schematic perspective view from above and to the side of a particular version of a dispensing system of a fluid storage and dispensing system in accordance with FIG. 28. FIG. 29B is a schematic perspective view from above and to the side of the dispensing system of FIG. 29A with a nozzle 705. FIG. 29A shows a version of the fluid dispenser 110 similar to the version of FIGS. 10 through 21. However, whereas in the version of FIGS. 10 through 21, the outlet end 165 is oriented at angle of about 90 degrees relative to the inlet end 160, in the version of FIGS. 28, 29A, and 29B, the outlet end 165 is oriented at an angle 900 that is other than about 90 degrees. More specifically, in the particular version of FIGS. 28, 29A, and 29B, the outlet end 165 is oriented an angle 900 of from about 90 degrees to about 160 degrees, and in one particular version is about 140 degrees to about 150 degrees, or about 135 degrees. The variation in angles 900 allows the fluid dispenser 110 to be better suited to pouring into a particular tank or the like and/or may be a matter of user preference. The version of FIG. 29B is similar to the version of FIG. 29A but with a nozzle 705 attached. The opening 140 of the fluid container 105 is designed at an optimal height and positioning such that when the user pivots the handle body 1010 on the fluid dispenser 110 downwards to its open position 1300, there is a comfortable distance between the user's hand and the top of a handle on the fluid container 105. This design feature allows for easy operation without obstruction or risk of injury from the handle body 1010 on the fluid container 105 striking the user's hand. The design of the fluid storage and dispensing system 100 allows for compact storage and transport by strategically positioning various components relative to one another. The fluid container 105 is designed such that when the fluid dispenser 110 is attached to it and then rotated to face the back, the nozzle 705 will be positioned at least partially above the handle of the fluid container 105 and/or at least partially above the fluid container 105. Specifically, the nozzle 705 will be slightly elevated relative to a handle, thereby allowing for clearance between the two components during rotation. This elevated position enables smooth rotation of the nozzle 705 without obstruction. Furthermore, by positioning the opening 140 of the fluid container 105 at the front end of the container, when the fluid dispenser 110 is rotated to face the back of the container, the nozzle 705 can extend across the full length of the container. This design allows for maximum storage efficiency and minimizes bulkiness during transport or storage.

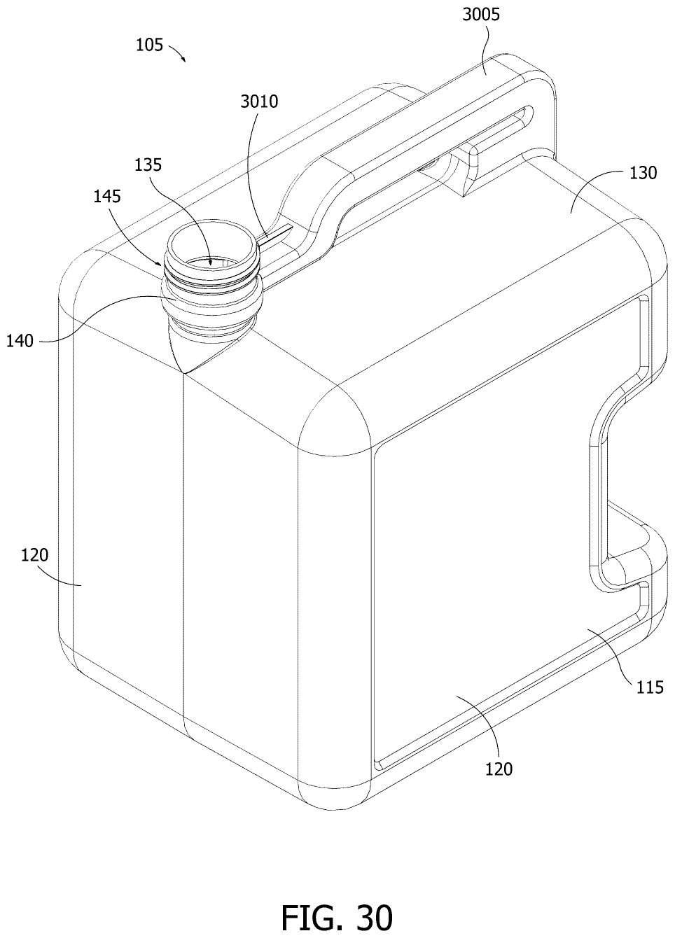

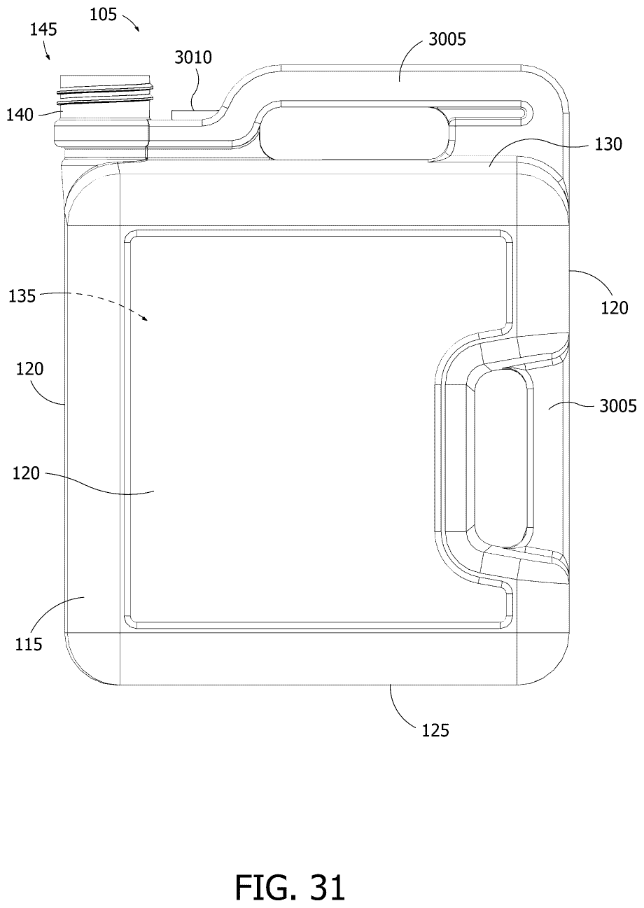

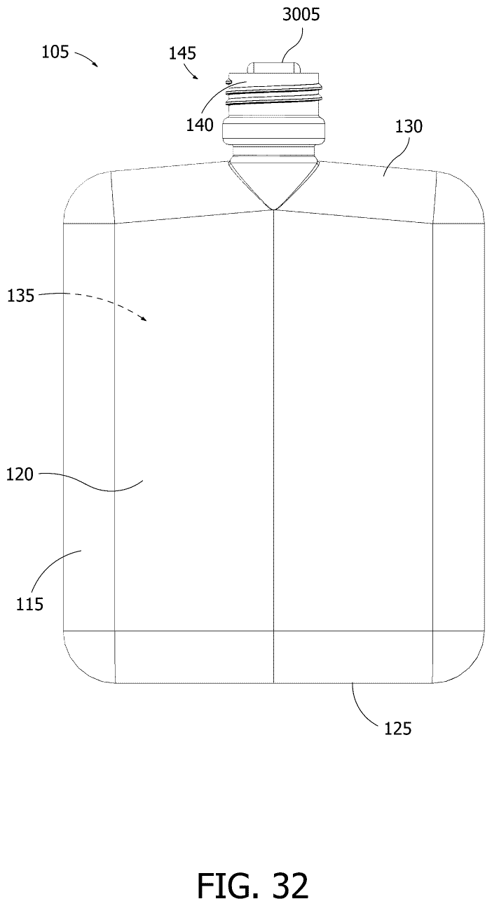

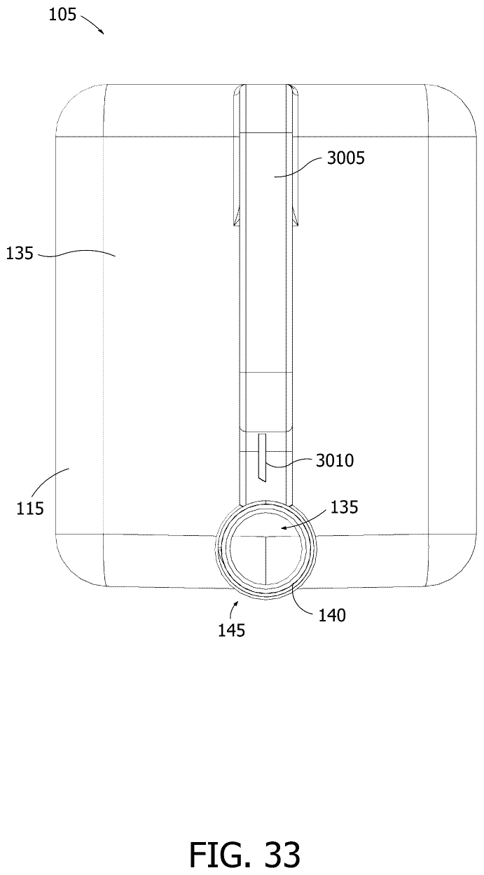

FIGS. 30-33 show another version of a fluid container 105 of the fluid storage and dispensing system 100 of the invention. FIG. 30 is a perspective view of the fluid container 105 of this version. FIG. 31 is a schematic side view of the fluid container 105 of FIG. 30. FIG. 32 is a schematic front view of the fluid container 105 of FIG. 30. FIG. 33 is a schematic top view of the fluid container 105 of FIG. 30. The fluid container 105 in this version has one or more handles 3005 and a child-resistant latching mechanism 3010 for the container cap 150.

In one use of the fluid storage and dispensing system 100 of the invention, in any of the versions and/or combinations of versions shown and described, the fluid container 105 is used to store a potentially harmful, hazardous, and/or combustible fluid. In one particular use, the fluid storage and dispensing system 100 is used to store and/or dispense a fuel, such as gasoline or the like. The fluid storage and dispensing system 100 provides a particularly advantageous system for storing and/or dispensing gasoline or the like for one or more of many reasons. For example, the fluid storage and dispensing system 100 of the invention provides venting of a container in a manner that does not increase hydrocarbon emissions, provides a self-venting dispenser that does not dispense gasoline frustratingly slowly and/or in turbulent streams, provides an automatic seal that helps decrease hydrocarbon emissions and is more universally applicable, provides a system that is easier to pour while opening the automatic seal, provides a system that is generally less awkward to operate, and/or provides a child-resistant mechanism that can be operated with one hand while in the process of opening the valve and pouring the fluid. These factors increase the likelihood of the fluid storage and dispending system 100 being properly used in compliance with regulations and good practices and decreases the likelihood of improper use.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person of ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A fluid dispenser for a fluid storage and dispensing system, the fluid dispenser comprising:
a dispenser body having an inlet end, an outlet end, and a dispenser passageway extending from the inlet end to the outlet end, wherein the inlet end is adapted to be in fluid communication with an opening in a fluid container, and wherein fluid from the fluid container can flow from the inlet end, through the dispenser passageway, and out the outlet end when fluid from the fluid container is to be dispensed; and
a venting system within the dispenser body, wherein the venting system communicates with the dispenser passageway, wherein the venting system comprises one or more air inlets that introduce air into the dispenser passageway, and wherein the venting system comprises a counterflow system adapted to allow air from the one or more air inlets to be introduced back into the fluid container through the inlet end of the dispenser body while fluid from the fluid container is flowing through the dispenser passageway from the inlet end of the dispenser body to the outlet end of the dispenser body,
wherein the venting system is adapted to vent a sufficient amount of air back into the fluid container to decrease negative pressure generated within the fluid container as a result of the fluid from the fluid container flowing into the fluid dispenser.

2. A fluid dispenser according to claim 1 wherein the one or more inlets are in communication with an air chamber within the dispenser body and wherein the counterflow system is in communication with the air chamber so that air within the air chamber can be vented to the fluid container as fluid is flowing out of the fluid container.

3. A fluid dispenser according to claim 2 wherein the counterflow system comprises a first channel that is at least predominantly for the passage of fluid in the direction from the inlet end of the dispenser body to the outlet end of the dispenser body, and a second channel that is at least predominantly for the passage of air in the direction from the air chamber to the inlet end of the dispenser body.

4. A fluid dispenser according to claim 3 wherein the first channel and the second channel are separated from one another by a channel barrier member.

5. A fluid dispenser according to claim 4 wherein the channel barrier member includes a flow directing portion that directs the flow of fluid in the first channel towards the outlet end and away from the air chamber, wherein an air chamber shielding member separates the air chamber and the second channel and directs fluid in the second channel towards the outlet end and away from the air chamber.

6. A fluid dispenser according to claim 5 wherein the flow directing portion includes an airflow shield that extends forwardly of the air chamber to help prevent air from the air chamber from flowing into the first channel.

7. A fluid dispenser according to claim 1 wherein the one or more inlets comprises one or more rear openings on a rear surface of the dispenser body.

8. A fluid dispenser according to claim 1 wherein the one or more inlets comprises one or more side openings on a side surface of the dispenser body.

9. A fluid dispenser according to claim 1 wherein the counterflow system of the venting system is formed by a cooperative arrangement between an outer shell of the dispenser body and an insert member that is insertable into an interior of the outer shell of the dispenser body.

10. A fluid dispenser according to claim 9 wherein the insert member includes a tab member that is latchingly receivable in a slot in the outer shell of the dispenser body, wherein the slot form an opening for the venting system.

11. A fluid dispenser according to claim 1 wherein the outlet end of the dispenser body is connectable to a nozzle.

12. A fluid dispenser for a fluid storage and dispensing system, the fluid dispenser comprising:
a dispenser body having an inlet end, an outlet end, and a dispenser passageway extending from the inlet end to the outlet end, wherein the inlet end is adapted to be in fluid communication with an opening in a fluid container, and wherein fluid from the fluid container can flow from the inlet end, through the dispenser passageway, and out the outlet end when fluid from the fluid container is to be dispensed; and
a self-closing valve system comprising a valve member and an actuating mechanism, wherein the valve member is biased into a closed position where the valve member prevents the flow of fluid from the fluid container into the dispenser body, and wherein the actuating mechanism comprises a handle body that can be rotated by a user to overcome the bias and move the valve member to an open position that allows fluid to flow from the fluid container into the dispenser body.

13. A fluid dispenser according to claim 12 wherein the handle body is rotatably mounted on the dispenser body and is moveable between a first rotational position where the valve member is in the closed position and a second rotational position where the handle body presses downwardly on a contact surface of the valve member, wherein the contact surface extends above the dispenser body when the handle body is in the first rotational position.

14. A fluid dispenser according to claim 13 wherein the handle body is mounted to a mounting platform on the dispenser body, wherein the mounting platform comprises a rotational surface comprising one or more protrusions, wherein the handle body comprises a protrusion engaging member, and wherein the one or more protrusions are positioned to correspond with the first rotational position of the handle body or the second rotational position of the handle body.

15. A fluid dispenser according to claim 13 wherein the actuating mechanism comprises a child-resistant mechanism that locks the handle body in a position where the handle body cannot be rotated to the second rotational position.

16. A fluid dispenser according to claim 15 wherein the child-resistant mechanism comprises a locking member that slides within the handle body between a locked configuration and an unlocked configuration.

17. A fluid dispenser according to claim 12 wherein the fluid dispenser comprises a venting system within the dispenser body, wherein the venting system communicates with the dispenser passageway, wherein the venting system comprises one or more air inlets that introduce air into the dispenser passageway, and wherein the venting system comprises a counterflow system adapted to allow air from the one or more air inlets to be introduced back into the fluid container through the inlet end of the dispenser body while fluid from the fluid container is flowing through the dispenser passageway from the inlet end of the dispenser body to the outlet end of the dispenser body, wherein the venting system is adapted to vent a sufficient amount of air back into the fluid container to decrease negative pressure generated within the fluid container as a result of the fluid from the fluid container flowing into the fluid dispenser.

18. A fluid dispenser according to claim 17 wherein the one or more inlets are in communication with an air chamber within the dispenser body and wherein the counterflow system is in communication with the air chamber so that air within the air chamber can be vented to the fluid container as fluid is flowing out of the fluid container, wherein the counterflow system comprises a first channel that is at least predominantly for the passage of fluid in the direction from the inlet end of the dispenser body to the outlet end of the dispenser body, and a second channel that is at least predominantly for the passage of air in the direction from the air chamber to the inlet end of the dispenser body, and wherein the first channel and the second channel are separated from one another by a channel barrier member.

19. A fluid dispenser according to claim 18 wherein the valve member extends through the channel barrier member.

20. A fluid storage and dispensing system comprising:
a fluid container comprising a container body having a hollow interior adapted to contain a fluid to be dispensed, the container body comprising an opening;
a fluid dispenser comprising a dispenser body having an inlet end, an outlet end, and a dispenser passageway extending from the inlet end to the outlet end, wherein the inlet end is adapted to be in fluid communication with the opening in a fluid container, wherein fluid from the fluid container can flow through the opening and into the dispenser body, and wherein the fluid can flow from the inlet end, through the dispenser passageway, and out the outlet end when fluid from the fluid container is to be dispensed;
a venting system within the dispenser body, wherein the venting system communicates with the dispenser passageway, wherein the venting system comprises one or more air inlets in the dispenser body that introduce air into the dispenser passageway, and wherein the venting system is adapted to vent a sufficient amount of air back into the fluid container through the opening in the fluid container to decrease negative pressure generated within the fluid container as a result of the fluid from the fluid container flowing into the fluid dispenser; and
a self-closing valve system comprising a valve member and an actuating mechanism, wherein the valve member extends through the dispenser body and is biased into a closed position where the valve member prevents the flow of fluid from the fluid container into the dispenser body, and wherein the actuating mechanism can be manipulated by a user to overcome the bias and move the valve member to an open position that allows fluid to flow from the fluid container into the dispenser body.
